(19) United States
(12) Patent Application Publication
(10) Pub. No.: US 2019/0299689 A1
(43) Pub. Date: Oct. 3, 2019

(54) Ink Ribbon Supporting Cassette and Printing Apparatus

(71) Applicant: Brother Kogyo Kabushiki Kaisha, Nagoya-shi (JP)

(72) Inventor: Kei Kondo, Nisshin-shi (JP)

(21) Appl. No.: 16/130,381

(22) Filed: Sep. 13, 2018

(30) Foreign Application Priority Data
Mar. 29, 2018 (JP) 2018-063492
Jun. 22, 2018 (JP) 2018-118531

(51) Int. Cl. B41J 35/04; B41J 35/28; B41J 33/16; B41J 33/00

(52) U.S. Cl. CPC B41J 35/04; B41J 33/003; B41J 33/16; B41J 35/28

(57) ABSTRACT

An ink ribbon supporting cassette includes: a plate; a shaft having a hole in a tip thereof; a rotating body being rotatable around the shaft; a spring biasing the rotating body in a direction separating from the plate; a column including a first bottom surface, a second bottom surface, a side surface, a through-hole penetrating between the first and second bottom surfaces, and a groove provided for the side surface; a shoulder bolt including a rod inserted in the through-hole of the column and the hole of the shaft to attach the column to the shaft, and a head; a projection provided for the rotating body, projecting toward a rotational center of the rotating body, and being configured to enter the groove of the column; and an elastic body disposed between the first bottom surface of the column and the head.

### CROSS REFERENCE TO RELATED APPLICATION

The present application claims priority from Japanese Patent Applications No. 2018-063492 filed on Mar. 29, 2018 and No. 2018-118531 filed on Jun. 22, 2018, the disclosures of which are incorporated herein by reference in its entirety.

### BACKGROUND

### Field of the Invention

The present invention relates to an ink ribbon supporting cassette by which an ink ribbon is supported, and relates to a printing apparatus that performs printing in a state where the ink ribbon supporting cassette has been installed therein.

### Description of the Related Art

There is known a heat transfer type printing apparatus that is used installed with a cassette having an ink ribbon supported therein. Japanese Patent Application Laid-open No. S63-165172 discloses a ribbon cassette holding apparatus for holding a ribbon cassette in a printing apparatus. The ribbon cassette has a ribbon winding shaft on which an ink ribbon has been wound. The ribbon cassette holding apparatus has a ribbon drive shaft and a spring. The ribbon drive shaft is fitted to a support shaft provided in a side plate and is capable of sliding with respect to the support shaft. The spring biases the ribbon drive shaft in a direction separating from the side plate. During installation of the ribbon cassette, the ribbon drive shaft is fitted to the ribbon winding shaft, and moves in a direction approaching the side plate while bending the spring. Due to this operation, a gear provided in the ribbon drive shaft engages with a drive gear provided in the side plate. The ribbon drive shaft rotates in response to drive of the drive gear, whereby the ink ribbon of the ribbon cassette is conveyed.

### SUMMARY

There is conceivably a configuration in which the ribbon is guided directly to the drive shaft, without using the ribbon cassette disclosed in Japanese Patent Application Laid-open No. S63-165172. When the ink ribbon is installed, it is more preferable for rotation of the shaft that has installed therein a roll on which the ink ribbon has been wound, to be restricted, because guide work of the ink ribbon is made easy. However, when a mechanism of the ribbon cassette holding apparatus described in Japanese Patent Application Laid-open No. S63-165172 is applied, rotation of the shaft is not restricted. Therefore, there is a possibility that during installation of the ink ribbon, slack occurs in the ink ribbon, and the guide work becomes troublesome.

An object of the present teaching is to provide an ink ribbon supporting cassette that makes guide work during installation of an ink ribbon easy, and to provide a printing apparatus that performs printing in a state where the ink ribbon supporting cassette has been installed therein.

According to a first aspect of the present teaching, there is provided an ink ribbon supporting cassette including: a plate; a shaft provided for the plate, the shaft extending in a direction intersecting the plate, the shaft having a hole formed in a tip of the shaft; a rotating body provided for at least a part of the shaft to be rotatable around the shaft; a spring disposed between the plate and the rotating body, the spring biasing the rotating body in a direction separating from the plate; a column provided for the tip of the shaft, the column including: a first bottom surface; a second bottom surface; and a side surface, a first distance between the first bottom surface and the plate being shorter than a second distance between the second bottom surface and the plate, the column including: a through-hole which penetrates between the first bottom surface and the second bottom surface; and a groove provided for the side surface and formed by a first wall and a second wall which extend from the second bottom surface toward the first bottom surface and face each other; a rod inserted in the through-hole of the column and the hole of the shaft to attach the column to the shaft; a head provided on an end, of the rod, opposite to the shaft; a projection provided for the rotating body, the projection projecting toward a rotational center of the rotating body, the projection being configured to enter the groove and to make contact with at least one of the first wall and the second wall of the column; and an elastic body disposed between the first bottom surface of the column and the head.

The column is pressed against the tip of the shaft in response to a biasing force of the elastic body. It becomes difficult for the column to rotate with respect to the shaft due to a frictional force between the shaft and the column. Moreover, rotation of the rotating body with respect to the column is restricted in a state where the projection provided in the rotating body has been inserted in the groove of the column. In other words, it becomes difficult for the rotating body to rotate with respect to the shaft in a state where the projection provided in the rotating body has been inserted in the groove of the column Therefore, due to the ink ribbon supporting cassette of the first aspect, rotation of the rotating body can be suppressed when a roll on which the ink ribbon has been wound is installed in the rotating body. Hence, a user can easily guide the ink ribbon during installation of the ink ribbon to the ink ribbon supporting cassette.

According to a second aspect of the present teaching, there is provided a printing apparatus including: an installing section in which the ink ribbon supporting cassette as defined in the first aspect is installed; a motor configured to rotate the rotating body of the ink ribbon supporting cassette that has been installed in the installing section; and a thermal head configured to heat an ink ribbon which has been fed out from the ink ribbon supporting cassette in response to rotation of the rotating body by the motor. Due to the second aspect, the ink ribbon supporting cassette enables the ink ribbon to be easily guided. Moreover, the ink ribbon supporting cassette is installed in the printing apparatus in a state where the ink ribbon has been firmly guided, that is, in a state where the ink ribbon has been firmly tensioned. Therefore, it is possible to reduce a risk that the ink ribbon interferes with a member of the printing apparatus, for example, the thermal head, or the like, whereby installation of the ink ribbon supporting cassette is hindered.

According to a third aspect of the present teaching, there is provided an ink ribbon supporting cassette including: a plate; a shaft provided for the plate, the shaft extending in a direction intersecting the plate, the shaft having a hole formed in a tip of the shaft; a rotating body provided for at least a part of the shaft to be rotatable around the shaft; a column provided for the tip of the shaft, the column including: a first bottom surface; a second bottom surface; and a side surface, a first distance between the first bottom surface and the plate being shorter than a second distance between the second bottom surface and the plate, the column including: a through-hole which penetrates between the first bottom surface and the second bottom surface; and a groove provided for the side surface and formed by a first wall and a second wall which extend from the second bottom surface toward the first bottom surface and face each other; a first rod inserted in the through-hole of the column and the hole of the shaft to attach the column to the shaft; a head provided on a side opposite to the shaft with respect to the first rod; a second rod provided for the rotating body, the second rod extending in a direction parallel to a rotational center of the rotating body, the second rod being movable with respect to the column in the direction parallel to the rotational center; a first projection provided for the second rod, the first projection projecting toward the rotational center, the first projection being configured to enter the groove and to make contact with the first wall and the second wall of the column; and an elastic body disposed between the first bottom surface of the column and the head.

In the ink ribbon supporting cassette according to the third aspect, the column is pressed against the tip of the shaft in response to a biasing force of the elastic body. It becomes difficult for the column to rotate with respect to the shaft due to a frictional force between the shaft and the column. Moreover, rotation of the rotating body with respect to the column is restricted in a state where the first projection of the second rod provided in the rotating body has been inserted in the groove of the column. In other words, it becomes difficult for the rotating body to rotate with respect to the shaft in a state where the first projection has been inserted in the groove of the column. Therefore, in the ink ribbon supporting cassette, rotation of the rotating body is suppressed when a roll on which an ink ribbon has been wound is installed in the rotating body. Hence, a user can easily guide the ink ribbon when installing the ink ribbon to the ink ribbon supporting cassette.

According to a fourth aspect of the present teaching, there is provided a printing apparatus including: an installing section in which the ink ribbon supporting cassette as defined in the third aspect is installed; a motor configured to rotate the rotating body of the ink ribbon supporting cassette that has been installed in the installing section; and a thermal head configured to heat an ink ribbon which has been fed out from the ink ribbon supporting cassette in response to rotation of the body by the motor. Due to the fourth aspect, the ink ribbon can be easily guided in the ink ribbon supporting cassette. Hence, the ink ribbon supporting cassette is installed in the printing apparatus in a state where the ink ribbon has been firmly guided, that is, in a state where the ink ribbon has been firmly tensioned. Therefore, a possibility that the ink ribbon interferes with a member of the printing apparatus, for example, the thermal head, or the like, whereby installation of the ink ribbon supporting cassette is hindered, can be reduced.

### BRIEF DESCRIPTION OF THE DRAWINGS

FIG. 1 is a perspective view of a printing apparatus and an ink ribbon supporting cassette.

FIG. 2 is a perspective view of the printing apparatus.

FIG. 3 is a front view of the printing apparatus.

FIG. 4 is a perspective view of the ink ribbon supporting cassette.

FIG. 5 is an exploded perspective view of a shaft.

FIG. 6 is a cross-sectional view of the shaft in a state where a rotating body has been disposed in a first position.

FIG. 7 is a cross-sectional view of the shaft in a state where the rotating body has been disposed in a second position.

FIG. 8 is a perspective view of a column viewed from a rear side.

FIG. 9 is a perspective view of the column viewed from a front side.

FIG. 10 is a plan view of the column.

FIG. 11 is an exploded perspective view of a shaft in the second embodiment.

FIG. 12 is a cross-sectional view of the shaft in a state where a second rod has been disposed in a first position, in the second embodiment.

FIG. 13 is a cross-sectional view of the shaft in a state where the second rod has been disposed in a second position, in the second embodiment.

FIG. 14 is a cross-sectional view depicting enlarged a connecting portion of a plate and a shaft, in the second embodiment.

FIG. 15 is a perspective view of a column in the second embodiment.

FIG. 16 is a front view of the column in the second embodiment.

FIG. 17 is a plan view of the column in the second embodiment.

FIG. 18 is a left side view of the column in the second embodiment.

FIG. 19 is an exploded perspective view depicting a tip vicinity of a rotating body in a third embodiment.

FIG. 20 is an exploded perspective view depicting the tip vicinity of the rotating body in the third embodiment.

### DESCRIPTION OF THE EMBODIMENTS

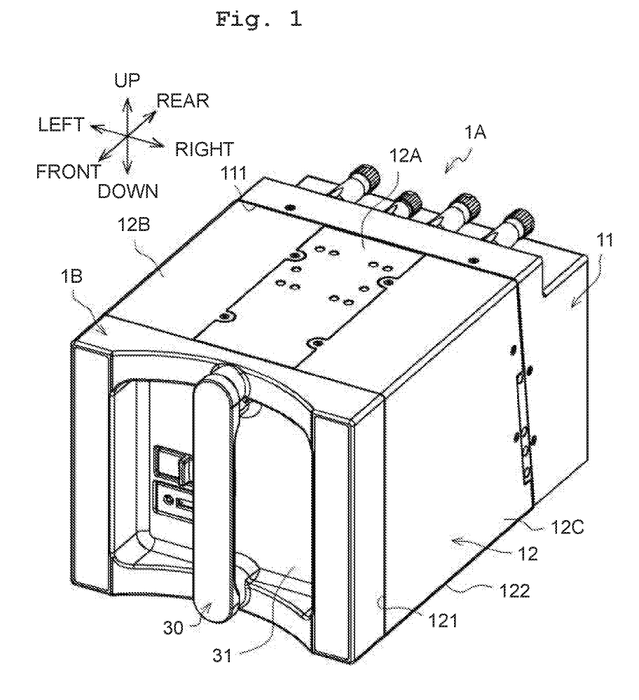

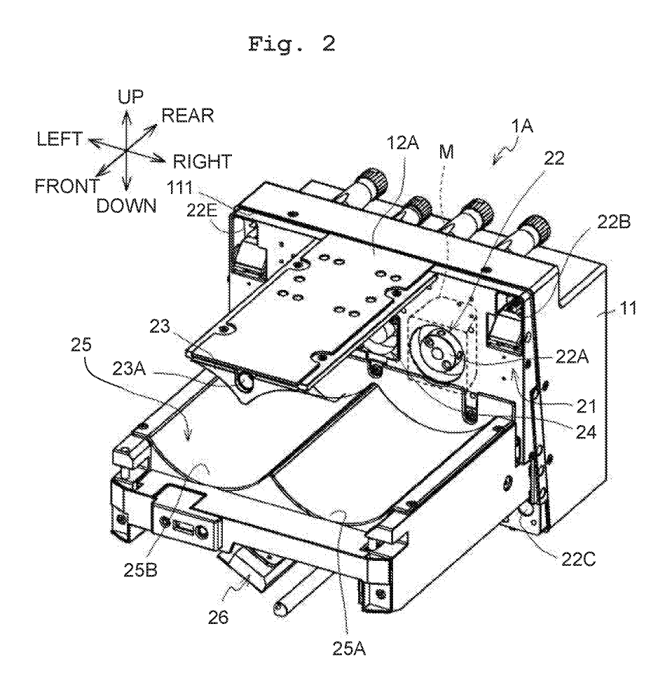

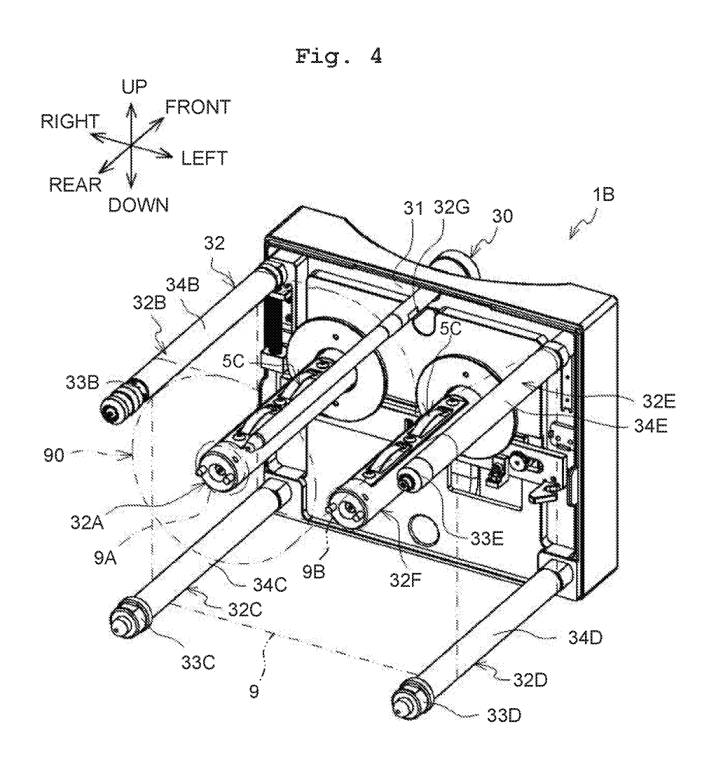

An embodiment of the present teaching will be described with reference to the drawings. A printing apparatus 1A depicted in FIG. 1 is a heat transfer type printing apparatus. The printing apparatus 1A executes printing on a printing medium conveyed by an unillustrated external device. A packing device conveying a packing material may be cited as a specific example of the external device. In this case, for example, the printing apparatus 1A is used incorporated in part of a conveyance line along which the printing medium is conveyed by the packing device. An ink ribbon supporting cassette 1B (hereafter, rephrased as “cassette 1B”) is installed in the printing apparatus 1A. The printing apparatus 1A feeds out an ink ribbon 9 (refer to FIG. 4) from the installed cassette 1B and heats the ink ribbon 9 by a thermal head 26 (refer to FIG. 2), thereby executing printing.

An upper side, a lower side, a left side, a right side, a front side, and a rear side of the printing apparatus 1A and the cassette 1B will be defined below in order to aid understanding of the description of the drawings. The upper side, the lower side, the left side, the right side, the front side, and the rear side of the printing apparatus 1A and the cassette 1B respectively correspond to an upper side, a lower side, an upper left slanting side, a lower right slanting side, a lower left slanting side, and an upper right slanting side of FIG. 1.

<Printing Apparatus 1A>

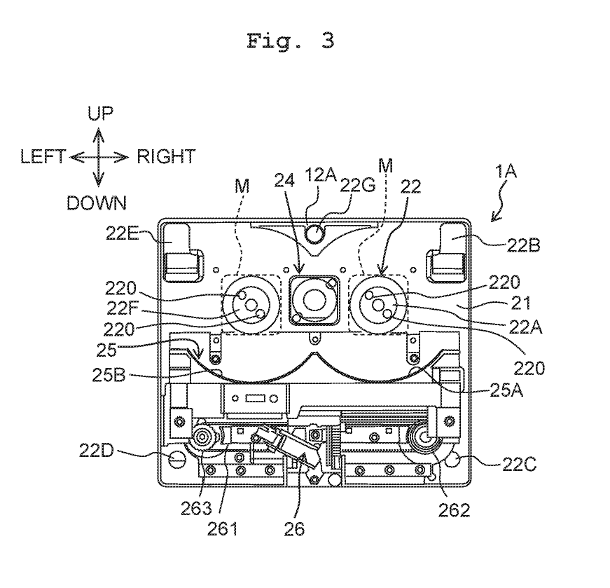

As depicted in FIG. 1, the printing apparatus 1A has substantially a rectangular parallelepiped shape. The cassette 1B is installed in such a manner that it can be installed/removed, from the front side, in/from the printing apparatus 1A. The printing apparatus 1A has casings 11, 12. As depicted in FIG. 2, the casing 11 is provided on the rear side of a base plate 21. The casing 11 has a rectangular shaped opening surrounded by a front end 111. The base plate 21 fits from the front side in the opening of the casing 11. The casing 11 covers peripheries of motors M (refer to FIGS. 2 and 3) provided on the rear side of the base plate 21, and a periphery of an unillustrated control board.

As depicted in FIG. 1, the casing 12 has an upper portion 12A and side portions 12B, 12C, that are each plate-like. The upper portion 12A and the side portions 12B, 12C are connected to the front end 111 of the casing 11. The upper portion 12A extends toward the front side from a central section in a left-right direction of an upper side portion of the front end 111. The side portion 12B extends toward the front side from more to the left side than a portion to which the upper portion 12A is connected, of the upper side portion of the front end 111, and from a left side portion of the front end 111. The side portion 12C extends toward the front side from more to the right side than a portion to which the upper portion 12A is connected, of the upper side portion of the front end 111, and from a right side portion of the front end 111. Respective front ends 121 of the upper portion 12A and the side portions 12B, 12C form an opening on the front side of the casing 12. A plate 31 of the cassette 1B covers the opening on the front side of the casing 12 in a state where the cassette 1B has been installed in the printing apparatus 1A. Respective lower ends 122 of the side portions 12B, 12C form an opening on the lower side of the casing 12. The thermal head 26 (refer to FIG. 2) is exposed from the opening on the lower side of the casing 12. In FIGS. 2 and 3, the casing 12 is omitted.

As depicted in FIGS. 2 and 3, the base plate 21 has substantially a square plate-like shape. As depicted in FIG. 3, a front surface of the base plate 21 is provided with installing sections 22A-22G for the cassette 1B to be installed, a fan 24, a partition wall 25, and the thermal head 26.

Shafts 32A-32G (refer to FIG. 4) of the cassette 1B are capable of engaging with, respectively, the installing sections 22A-22G. The installing section 22A is provided more to the upper side than a center in an up-down direction and more to the right side than a center in the left-right direction of the base plate 21. The installing section 22F is provided more to the upper side than the center in the up-down direction and more to the left side than the center in the left-right direction of the base plate 21. The installing sections 22A, 22F are each of circular columnar shape (refer to FIG. 2), and are aligned in the left-right direction. Holes 220 recessing to the rear side are formed in respective front surfaces of the installing sections 22A, 22F. Rotating shafts of the motors M are connected from the rear side to, respectively, the installing sections 22A, 22E The installing sections 22A, 22F rotate in response to rotation of the motors M.

The installing section 22B is provided in an upper right corner of the base plate 21. The installing section 22C is provided in a lower right corner of the base plate 21. The installing section 22D is provided in a lower left corner of the base plate 21. The installing section 22E is provided in an upper left corner of the base plate 21. The installing section 22G is provided in an upper end section in the center in the left-right direction of the base plate 21. Hereafter, when the installing sections 22A-22G are not distinguished, they will be referred to collectively as “installing sections 22”. As depicted in FIG. 2, a columnar support 23 extends toward the front side from a vicinity of the installing section 22G (refer to FIG. 3) of the base plate 21. The support 23 is provided with a through-hole 23A extending to the rear side toward the installing section 22G from a front end of the support 23.

As depicted in FIG. 3, the fan 24 is provided between the installing sections 22A, 22F. The fan 24 is an air blower having a plurality of rotatable blades. The fan 24 has a motor built in thereto. By rotation of the plurality of blades, the fan 24 causes air in a region more to the rear side than the base plate 21 to flow toward the front side.

As depicted in FIG. 2, the partition wall 25 partitions in the up-down direction a region covered by the casing 12 (refer to FIG. 1). The partition wall 25 has a curved plate-like shape. The partition wall 25 extends toward the front side from more to the lower side than the installing sections 22A, 22F of the base plate 21. The partition wall 25 has curved portions 25A, 25B that are aligned in the left-right direction. As depicted in FIG. 3, the curved portions 25A, 25B are arc-shaped when viewed from the front side. A position of an arc center of the curved portion 25A when viewed from the front side substantially coincides with a position of a rotational center of the installing section 22A. A position of an arc center of the curved portion 25B when viewed from the front side substantially coincides with a position of a rotational center of the installing section 22F.

The thermal head 26 is provided in a portion on the lower side of the partition wall 25 between the installing sections 22C, 22D in the left-right direction. The thermal head 26 is a line thermal head having a plurality of heating elements aligned linearly in a front-rear direction. The thermal head 26 is connected to a loop-like belt 261. The belt 261 is bridged between a gear 262 provided in a vicinity of the installing section 22C, and a gear 263 provided in a vicinity of the installing section 22D. The gear 263 rotates in response to rotation of an unillustrated motor. The belt 261 rotates in response to rotation of the gear 263. The thermal head 26 is capable of moving in the left-right direction between the respective vicinities of the installing sections 22C, 22D, in response to rotation of the belt 261.

<Cassette 1B>

As depicted in FIG. 4, the cassette 1B includes the plate 31 and the shafts 32A-32G (hereafter, when the shafts 32A-32G are not distinguished, they will be referred to collectively as “shafts 32”). The plate 31 is a substantially square plate-like base, and has substantially an identical shape to that of the opening on the front side of the casing 12 (refer to FIG. 1). A handle 30 is provided in a front surface of the plate 31 (refer to FIG. 1).

The shaft 32A is provided more to the upper side than a center in the up-down direction and more to the right side than a center in the left-right direction of the plate 31. The shaft 32F is provided more to the upper side than the center in the up-down direction and more to the left side than the center in the left-right direction of the plate 31. The shafts 32A, 32F are aligned in the left-right direction. A cylindrically-shaped spool 9A to which one end of the ink ribbon 9 is connected, is installed in the shaft 32A. The ink ribbon 9 not yet used is wound in roll form on the spool 9A. Hereafter, the ink ribbon 9 in a state of having been wound in roll form will be referred to as a “ribbon roll 90”. A cylindrically-shaped spool 9F to which the other end of the ink ribbon 9 is connected, is installed in the shaft 32E The ink ribbon 9 extending so as to span between the spools 9A, 9F is stretched over the shafts 32B-32E. In a state where the cassette 1B has been installed in the printing apparatus 1A, a tip of the shaft 32A is engaged with the installing section 22A (refer to FIG. 3), and a tip of the shaft 32F is engaged with the installing section 22F (refer to FIG. 3).

The shaft 32B is provided in a top right corner of the plate 31. The shaft 32B has a shaft 33B and a rotating body 34B. The shaft 33B has a circular columnar shape, and extends toward the rear side from the plate 31. The rotating body 34B has a circular columnar shape, and is held in such a manner that it can be rotated around the shaft 33B. A tip of the shaft 32B engages with the installing section 22B (refer to FIG. 3) in a state where the cassette 1B has been installed in the printing apparatus 1A.

The shaft 32C is provided in a bottom right corner of the plate 31. The shaft 32D is provided in a bottom left corner of the plate 31. The shaft 32E is provided in a top left corner of the plate 31. The shaft 32G is provided in an upper end section in the center in the left-right direction of the plate 31. Configurations of the shafts 32C-32E are substantially identical to that of the shaft 32B. The shaft 32C has a shaft 33C and a rotating body 34C; the shaft 32D has a shaft 33D and a rotating body 34D; and the shaft 32E has a shaft 33E and a rotating body 34E. The shaft 32G has a circular columnar shape. In a state where the cassette 1B has been installed in the printing apparatus 1A, tips of the shafts 32B, 32C, 32D, 32E respectively engage with the installing sections 22B, 22C, 22D, 22E (refer to FIG. 3). A tip of the shaft 32G enters the through-hole 23A of the support 23, and engages with the installing section 22E (refer to FIG. 3).

The ink ribbon 9 extending from the spool 9A that has been installed in the shaft 32A extends to the right side toward the shaft 32B, changes direction by contacting the rotating body 34B of the shaft 32B, and extends to the lower side toward the shaft 32C. The ink ribbon 9 changes direction by contacting the rotating body 34C of the shaft 32C, and extends to the left side toward the shaft 32D. The ink ribbon 9 changes direction by contacting the rotating body 34D of the shaft 32D, and extends to the upper side toward the shaft 32E. The ink ribbon 9 changes direction by contacting the rotating body 34E of the shaft 32E, and extends to the lower right slanting side toward the spool 9F that has been installed in the shaft 32F. The ink ribbon 9 is fed out from the ribbon roll 90 of the spool 9A and wound onto the spool 9F by the shafts 32A, 32F rotating. The rotating bodies 34B-34E of the shafts 32B-32E respectively rotate with respect to the shafts 33B-33E, in response to movement of the ink ribbon 9.

<Shafts 32A, 32F>

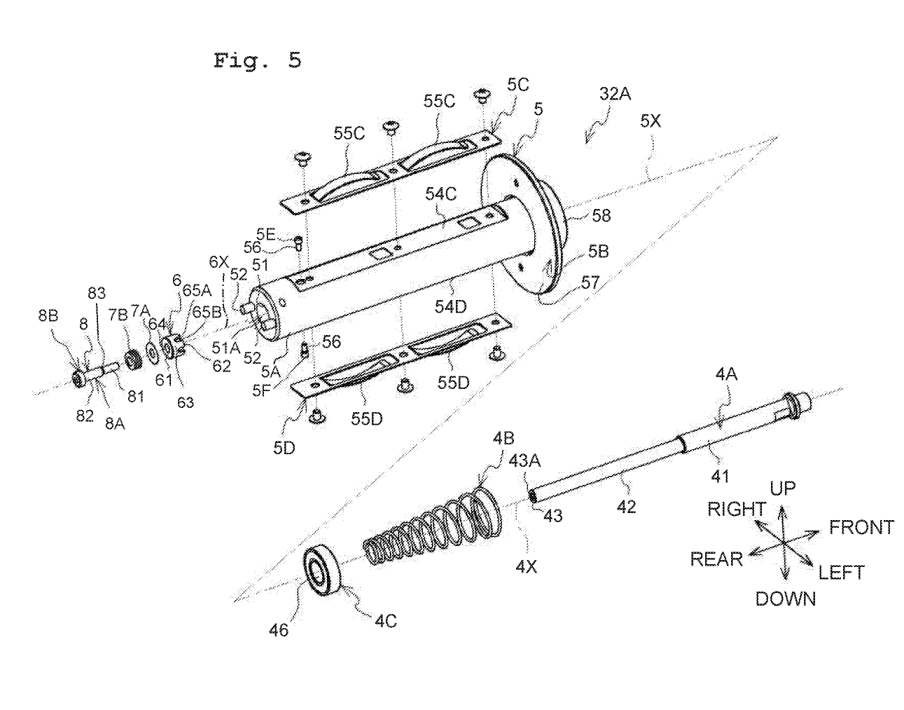

The shafts 32A, 32F have identical configurations. Hereafter, the shaft 32A will be specifically described as an example, and description of the shaft 32F will be omitted. As depicted in FIG. 5, the shaft 32A includes the likes of a shaft 4A, a spring 4B, a rotating body 5, a column 6, a flat washer 7A, a spring washer 7B, and a shoulder bolt 8.

<Shaft 4A>

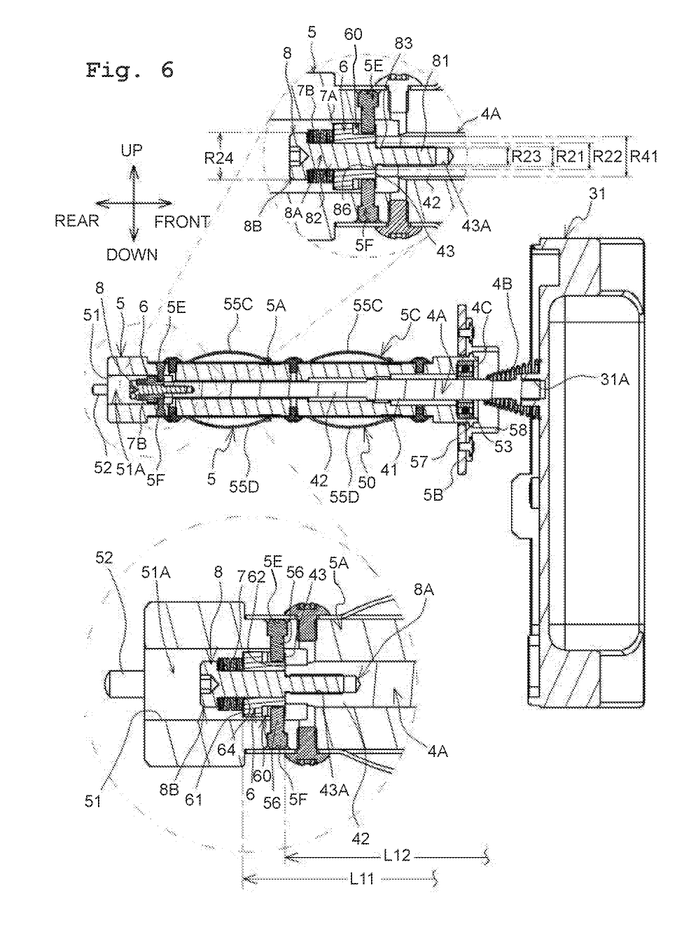

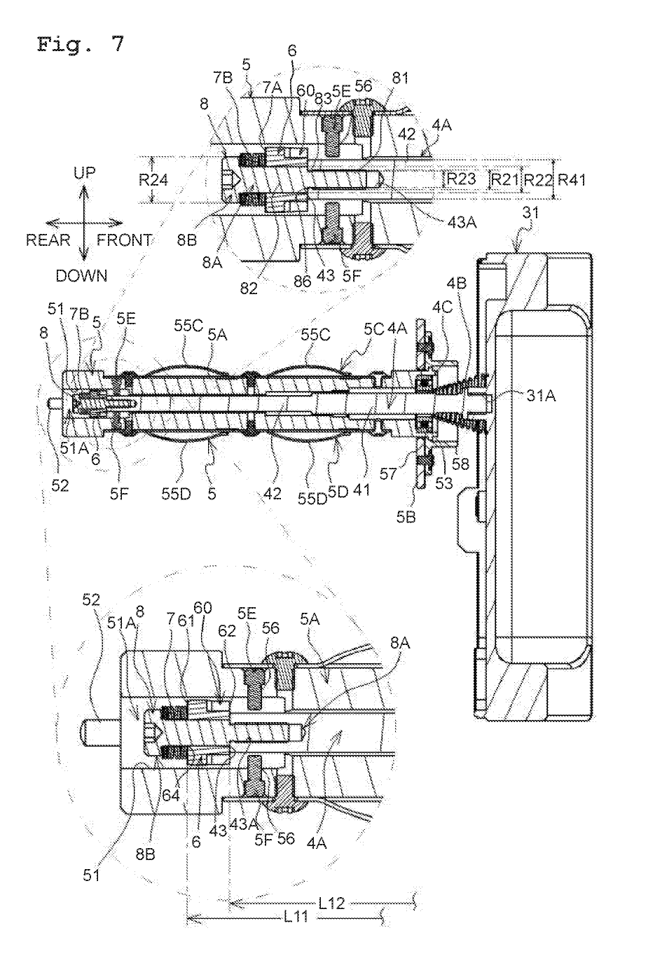

The shaft 4A has substantially a circular columnar shape. As depicted in FIGS. 6 and 7, the shaft 4A is provided to the plate 31 and extends to the rear side from a rear surface of the plate 31. An extending direction of the shaft 4A orthogonally intersects the plate 31. As depicted in FIG. 5, the shaft 4A has a large diameter portion 41 and a small diameter portion 42 whose diameters differ. The diameter of the large diameter portion 41 is larger than the diameter of the small diameter portion 42. The large diameter portion 41 and the small diameter portion 42 are arranged in a straight line in the front-rear direction. The large diameter portion 41 is disposed more to the front side than the small diameter portion 42 is. As depicted in FIGS. 6 and 7, a front end of the large diameter portion 41 fits in a hole 31A provided in the rear surface of the plate 31. Rotation of the shaft 4A with respect to the plate 31 is restricted. A front end of the small diameter portion 42 is connected to a rear end of the large diameter portion 41. A rear end of the small diameter portion 42 corresponds to a tip of the shaft 4A. As depicted in FIG. 5, a virtual axis passing along centers of the large diameter portion 41 and the small diameter portion 42 is defined as a “reference axis 4X”. The reference axis 4X extends in the front-rear direction.

A hole 43A recessing toward the front side is formed in an end surface of a tip 43 of the shaft 4A. A cross-sectional shape of the hole 43A is circular. The hole 43A extends along the reference axis 4X. A screw thread is formed in an inner wall of the hole 43A. The shoulder bolt 8 is screwed into the hole 43A.

<Rotating Body 5>

As depicted in FIG. 5, the rotating body 5 includes a main body 5A, a pedestal 5B, plate springs 5C, 5D, and projections 5E, 5F. The main body 5A has substantially a cylindrical shape. Two bottom surfaces of the main body 5A face each other in the front-rear direction. The main body 5A has a through hole 51 that extends so as to span between the two bottom surfaces. A cross-sectional shape of the through-hole 51 is circular. A diameter of the through-hole 51 is substantially identical to the diameter of the large diameter portion 41 of the shaft 4A. Hereafter, a space surrounded by the through-hole 51 will be referred to as a “cavity 51A”. The bottom surface on the rear side of the main body 5A is provided with two projections 52 that project to the rear side. The two projections 52 each have a circular columnar shape, and are disposed in facing positions sandwiching the through-hole 51 of the bottom surface on the rear side of the main body 5A. As depicted in FIGS. 6 and 7, the bottom surface on the front side of the main body 5A is provided with a hole 53 that recesses in the rear direction. A cross-sectional shape of the hole 53 is circular. A front end of the through-hole 51 communicates with a bottom surface of the hole 53. The hole 53 is fitted with a bearing 4C. As depicted in FIG. 5, a through-hole 46 (refer to FIG. 5) of the bearing 4C extends in the front-rear direction.

As depicted in FIGS. 6 and 7, the shaft 4A is inserted in the cavity 51A. In this case, the main body 5A is disposed so as to cover an entire region around the shaft 4A. The main body 5A is capable of rotating around the shaft 4A that has been inserted in the cavity 51A. As depicted in FIG. 5, a rotational center in the case that the main body 5A of the rotating body 5 rotates, is referred to as a “rotational center 5X”. The rotational center 5X coincides with the reference axis 4X of the shaft 4A in a state where the shaft 4A has been inserted in the cavity 51A. In other words, the rotating body 5 is capable of rotating around the shaft 4A centered on the reference axis 4X of the shaft 4A. The bearing 4C reduces friction between the shaft 4A and the main body 5A during rotation of the main body 5A.

Furthermore, the main body 5A is capable of moving in the front-rear direction along the shaft 4A that has been inserted in the cavity 51A. FIG. 6 depicts a state where the main body 5A has moved in a rearward direction with respect to the shaft 4A. FIG. 7 depicts a state where the main body 5A has moved in a frontward direction with respect to the shaft 4A. Hereafter, a position of the rotating body 5 depicted in FIG. 6 will be referred to as a “first position”, and a position of the rotating body 5 depicted in FIG. 7 will be referred to as a “second position”. The rotating body 5 is positioned in the first position mainly when the cassette 1B is not installed in the printing apparatus 1A. Guiding of the ink ribbon to the rotating body 5 by a user is performed mainly when the rotating body 5 is positioned in the first position. The rotating body 5 is positioned in the second position mainly when the cassette 1B is installed in the printing apparatus 1A. The ink ribbon 9 is conveyed by rotation of the rotating body 5 and printing is executed, mainly when the rotating body 5 is positioned in the second position.

As depicted in FIG. 5, a plane surface 54C is provided at an upper end of a side surface of the main body 5A, and a plane surface 54D is provided at a lower end of the side surface of the main body 5A. The plane surfaces 54C, 54D are each formed by part of the side surface of the main body 5A being cut out. A plurality of through-holes communicating with the cavity 51A are provided in the plane surfaces 54C, 54D. The plate spring 5C is fixed to the plane surface 54C by a plurality of raised countersunk head screws being screwed into the plurality of through-holes of the plane surface 54C. The plate spring 5D is fixed to the plane surface 54D by a plurality of raised countersunk head screws being screwed into the plurality of through-holes of the plane surface 54D. The plate springs 5C, 5D have an identical shape. The plate spring 5C has two curved sections 55C that curve convexly toward an opposite side to the main body 5A. The plate spring 5D has two curved sections 55D that curve convexly toward an opposite side to the main body 5A.

The projection 5E is inserted in the through-hole in a rear end vicinity of the plane surface 54C. The projection 5F is inserted in the through-hole in a rear end vicinity of the plane surface 54D. The projections 5E, 5F are each flat screws having rods 56. As depicted in FIGS. 6 and 7, parts on tip sides of the rods 56 of the projections 5E, 5F each project from the through-hole 51 toward the rotational center 5X, and are positioned on the inside of the cavity 51A.

As depicted in FIG. 5, the pedestal 5B is fixed to a front end of the main body 5A. The pedestal 5B has a plate portion 57 and a cylinder portion 58. The plate portion 57 has a circular plate-like shape, and orthogonally intersects the rotational center 5X. The front end of the main body 5A is inserted in a through-hole provided in a center of the plate portion 57. The cylinder portion 58 is provided in a front surface of the plate portion 57, and is fixed to the front end of the main body 5A. As depicted in FIGS. 6 and 7, a diameter of the through-hole of the cylinder portion 58 is larger than a diameter of the main body 5A.

<Spring 4B>

As depicted in FIG. 5, the spring 4B is a conical compression coil spring. The shaft 4A is inserted in a center of the spring 4B. As depicted in FIGS. 6 and 7, the spring 4B is disposed in a vicinity of the rear surface of the plate 31. The spring 4B is provided between the plate 31 and the rotating body 5. The spring 4B is sandwiched from both front and rear sides by the plate 31 and the rotating body 5. A biasing force acting on the rotating body 5 from the spring 4B acts in a direction separating from the plate 31 along the shaft 4A, that is, in the rearward direction. The rotating body 5 moves in the direction separating from the plate 31 and is held in the first position (refer to FIG. 6), in response to the biasing force received from the spring 4B. On the other hand, when an external force in the frontward direction acts on the rotating body 5, the rotating body 5 moves in a direction approaching the plate 31 and is held in the second position (refer to FIG. 7), opposing the biasing force of the spring 4B.

<Column 6>

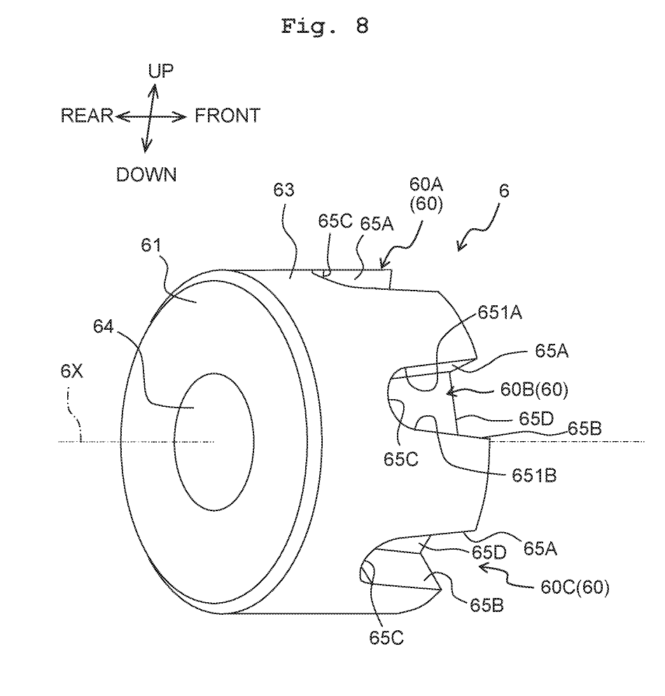

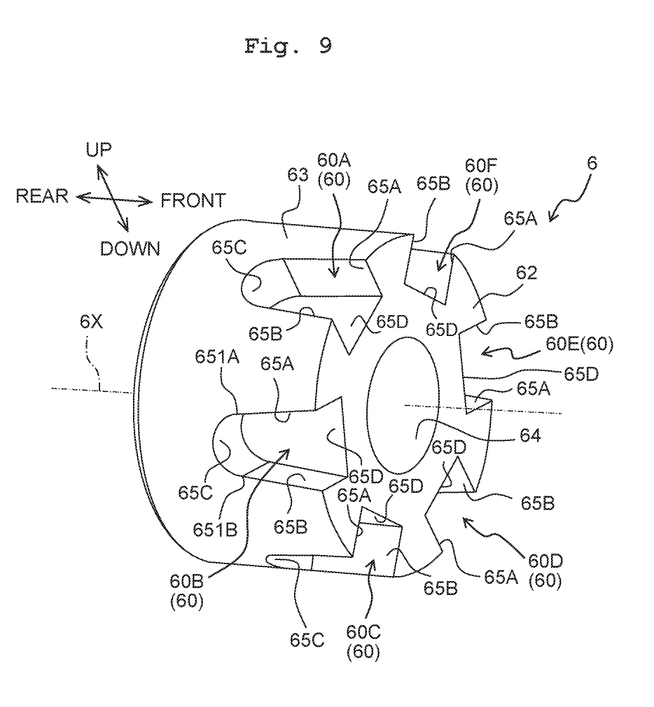

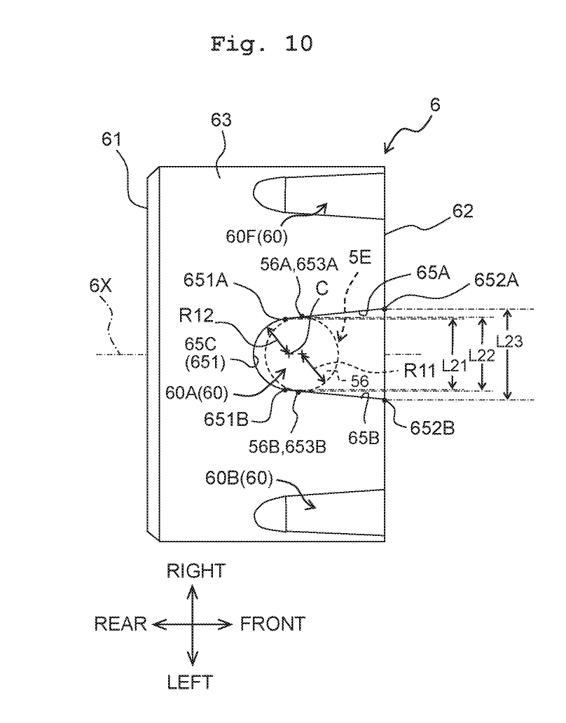

As depicted in FIGS. 6 and 7, the column 6 is provided to the tip 43. The column 6 is attached to the shaft 4A by the shoulder bolt 8. As depicted in FIGS. 8-10, the column 6 has a circular columnar shape. A height of the column 6 is shorter than a diameter of the column 6. The column 6 includes a first bottom surface 61 (refer to FIGS. 8 and 10), a second bottom surface 62 (refer to FIGS. 9 and 10), a side surface 63, a through-hole 64, and grooves 60A, 60B, 60C, 60D, 60E, 60F (refer to FIG. 9).

The first bottom surface 61 and the second bottom surface 62 face each other in the front-rear direction. The first bottom surface 61 is disposed more to the rear side than the second bottom surface 62 is. As depicted in FIGS. 6 and 7, a distance between the rear surface of the plate 31 and the first bottom surface 61 is defined as a “first distance L11”, and a distance between the rear surface of the plate 31 and the second bottom surface 62 is defined as a “second distance L12”. In this case, the second distance L12 is smaller than the first distance L11. Part of the second bottom surface 62 contacts an end surface of the tip 43 of the shaft 4A. The first bottom surface 61 contacts the flat washer 7A (refer to FIG. 5). As depicted in FIGS. 8 and 9, the through-hole 64 penetrates between the first bottom surface 61 and the second bottom surface 62. Hereafter, a virtual axis extending in the front-rear direction passing along a center of the through-hole 64 will be referred to as a “reference axis 6X”.

As depicted in FIG. 9, the grooves 60A, 60B, 60C, 60D, 60E, 60F are provided in the side surface 63 of the column 6. The grooves 60A-60F are arranged at equal intervals in a circumferential direction of the side surface 63. The grooves 60A-60F have an identical shape. Each of the groove 60A and groove 60D, the groove 60B and groove 60E, and the groove 60C and groove 60F face each other sandwiching the through-hole 64. Hereafter, when the grooves 60A-60F are not distinguished, they will be referred to collectively as “grooves 60”.

The grooves 60 are formed by a first wall 65A, a second wall 65B, and a third wall 65D that are provided in the side surface 63 of the column 6. The first wall 65A, the second wall 65B, and the third wall 65D each extend from the second bottom surface 62 toward the first bottom surface 61. The first wall 65A and the second wall 65B are each plane surfaces, and each intersect the circumferential direction of the side surface 63. The first wall 65A and the second wall 65B each extend from the side surface 63 toward the through-hole 64. The first wall 65A and the second wall 65B face each other. The third wall 65D is a plane surface, and orthogonally intersects a radial direction centered on the reference axis 6X. The third wall 65D is positioned between the side surface 63 and the through-hole 64 in a direction orthogonally intersecting the reference axis 6X. The third wall 65D is connected to ends closest to the through-hole 64, of each of the first wall 65A and the second wall 65B.

As depicted in FIG. 10, the first wall 65A and the second wall 65B each extend linearly along a direction slanting with respect to a direction that the first bottom surface 61 and the second bottom surface 62 face each other (the front-rear direction). A space between the first wall 65A and the second wall 65B gets continuously larger as the second bottom surface 62 is approached from the first bottom surface 61. In other words, the space between the first wall 65A and the second wall 65B gets continuously smaller as the first bottom surface 61 is approached from the second bottom surface 62. The first wall 65A and the second wall 65B curve from, respectively, a place 651A and a place 651B along the way of approaching the first bottom surface 61 from the second bottom surface 62, and thereby form an arc 651. Moreover, the first wall 65A and the second wall 65B are joined at an end section 65C. Since, as mentioned above, the space between the first wall 65A and the second wall 65B gets continuously larger as the second bottom surface 62 is approached from the first bottom surface 61, then, for example, a space L23 between an end 652A of the first wall 65A and an end 652B of the second wall 65B is larger than a space L21 between the place 651A of the first wall 65A and the place 651B of the second wall 65B.

There is defined a virtual axis C that passes through a certain position of the third wall 65D, of a virtual axis extending in a radial direction centering on the reference axis 6X. In this case, the arc 651 is part of a circle of radius R12 centered on the virtual axis C.

As depicted in FIG. 7, when the rotating body 5 has been disposed in the second position, the grooves 60 are disposed in positions separated to the rear side from the rods 56 of the projections 5E, 5F. In a process of the rotating body 5 moving from the second position to the first position (refer to FIG. 6), the rods 56 of the projections 5E, 5F respectively enter from the front side two of the grooves 60 facing each other sandwiching the through-hole 64 (refer to FIGS. 8 and 9). As depicted in FIG. 6, when the rotating body 5 has been disposed in the first position, the rods 56 of the projections 5E, 5F are disposed on the respective insides of the two grooves 60 facing each other sandwiching the through-hole 64.

As depicted in FIG. 10, in a state where, for example, the rod 56 of the projection 5E is disposed in the groove 60A, a one end 56A of the rod 56 abuts on a certain position 653A of the first wall 65A, and an other end 56B of the rod 56 abuts on a certain position 653B of the second wall 65B. The certain position 653A and the certain position 653B are positioned between the first bottom surface 61 and the second bottom surface 62 in the front-rear direction. The certain position 653A is positioned between the place 651A and the end 652A, of the first wall 65A. The certain position 653B is positioned between the place 651B and the end 652B, of the second wall 65B. The rod 56 does not abut on the end section 65C. That is, a gap is formed between the rod 56 of the projection 5E and the end section 65C.

A width L22 between the one end 56A and the other end 56B is identical to a space between the certain positions 653A, 653B. The space L21 between the places 651A, 651B is smaller than the width L22. The space L23 between the ends 652A, 652B on a second bottom surface 62 side is larger than the width L22.

<Shoulder Bolt 8>

The shoulder bolt 8 holds in the tip 43 of the shaft 4A the column 6, the flat washer 7A, and the spring washer 7B. As depicted in FIG. 5, the shoulder bolt 8 is configured by a rod 8A and a head 8B. The head 8B is provided to a rear end of the rod 8A. The head 8B has a larger diameter than the rod 8A. In other words, the head 8B is larger than the rod 8A in a direction orthogonally intersecting the rotational center 5X.

The rod 8A is inserted in the through-hole 64 (refer to FIGS. 8 and 9) of the column 6 and the hole 43A of the shaft 4A, and attaches the column 6 to the tip 43 of the shaft 4A. The rod 8A extends in the front-rear direction. As depicted in FIGS. 6 and 7, the rod 8A has a first portion 81, a second portion 82, and a third portion 83. The first portion 81, the second portion 82, and the third portion 83 each have a circular columnar shape and each extend in the front-rear direction. The first portion 81, the second portion 82, and the third portion 83 are disposed aligned in the front-rear direction. The first portion 81 is disposed in front of the third portion 83, and the second portion 82 is disposed behind the third portion 83. The third portion 83 is disposed between the first portion 81 and the second portion 82.

The first portion 81, the second portion 82, and the third portion 83 have respectively differing diameters. A diameter R21 of the first portion 81 is substantially identical to a diameter of the hole 43A of the shaft 4A. A diameter R22 of the second portion 82 is larger than the diameter R21. A diameter R23 of the third portion 83 is smaller than the diameter R21. The diameters R21, R22, R23 are smaller than a diameter R41 of the small diameter portion 42 of the shaft 4A.

A screw thread is formed in a side surface of the first portion 81. The first portion 81 and the third portion 83 are inserted from the rear side in the hole 43A of the shaft 4A. The rod 8A is fixed to the shaft 4A by the screw thread of the side surface of the first portion 81 being screwed into the screw thread of the inner wall of the hole 43A. The head 8B is connected to a rear end of the second portion 82. The first portion 81 is disposed in front of the second portion 82. The second portion 82 is disposed in front of the head 8B. The second portion 82 is disposed between the first portion 81 and the head 8B. An end surface 86 on an opposite side to the head 8B of the second portion 82 abuts on part of the end surface of the tip 43 of the shaft 4A.

The head 8B is provided on an opposite side to the shaft 4A of the rod 8A. A diameter R24 of the head 8B is larger than any of the diameters R21, R22, R23, R41.

<Flat Washer 7A, Spring Washer 7B>

As depicted in FIGS. 5, 6, and 7, the flat washer 7A and the spring washer 7B are provided between the first bottom surface 61 of the column 6 and the head 8B of the shoulder bolt 8. The flat washer 7A is made of a resin. The spring washer 7B is made of a metal. As depicted in FIGS. 6 and 7, the second portion 82 of the rod 8A of the shoulder bolt 8 is inserted in a through-hole in a center of the spring washer 7B. The second portion 82 of the rod 8A of the shoulder bolt 8 is inserted in a through-hole in a center of the flat washer 7A. By the first portion 81 of the rod 8A of the shoulder bolt 8 being fixed to the shaft 4A, the flat washer 7A and the spring washer 7B are supported by the shaft 4A via the column 6. The flat washer 7A is disposed on a column 6 side of the spring washer 7B, and contacts the first bottom surface 61 (refer to FIGS. 8 and 9) of the column 6. The spring washer 7B is disposed on an opposite side to the column 6 of the flat washer 7A, and contacts the head 8B. The flat washer 7A is pressed against the first bottom surface 61 (refer to FIGS. 8 and 9) of the column 6 by a biasing force of the spring washer 7B. The flat washer 7A is provided to suppress abrasion of the column 6.

<Summary of Operation of Cassette 1B>

A description of the cassette 1B when the rotating body 5 is positioned in the first position, will be given using FIG. 6. The cassette 1B is assumed to be not installed in the printing apparatus 1A at this time. As depicted in FIGS. 6 and 7, the spring washer 7B is sandwiched in the front-rear direction by the first bottom surface 61 of the column 6 and the head 8B of the shoulder bolt 8. Due to the spring washer 7B being sandwiched by the first bottom surface 61 and the head 8B of the shoulder bolt 8, the spring washer 7B exerts a biasing force pressing the column 6 onto the shaft 4A. As a result of this biasing force due to the spring washer 7B, a frictional force, that is, a braking force occurs between the second bottom surface 62 of the column 6 and the end surface of the tip 43 of the shaft 4A. Therefore, due to the spring washer 7B, the column 6 is supported in a rotatable manner with respect to the shaft 4A, while receiving an appropriate frictional force. That is, although the column 6 is supported in a rotatable manner by the shaft 4A, the column 6 does not rotate too much with respect to the shaft 4A. The projections 5E, 5F of the rotating body 5 in the first position are inserted in the grooves 60 of the column 6, and the rods 56 of the projections 5E, 5F abut on the first wall 65A and the second wall 65B (refer to FIG. 10) forming the grooves 60. Therefore, the rotating body 5 is enabled to rotate along with the column 6. Due to the column 6 receiving the frictional force, that is, the braking force, the rotating body 5 also receives an appropriate force so as to prevent it from rotating too much with respect to the shaft 4A, and rotation of the rotating body 5 is suppressed. This force received by the rotating body 5 applies an appropriate back-tension to the ink ribbon 9 when the user is guiding the ink ribbon 9 to the rotating body 5. Therefore, guide work of the ink ribbon 9 by the user is made easy. Moreover, the spring washer 7B causes a biasing force in a direction approaching the column 6 to act on the flat washer 7A. Therefore, a frictional force occurs also between the flat washer 7A and the column 6. The flat washer 7A suppresses abrasion of the column 6.

Note that the rotating body 5 receives from the spring 4B a biasing force in the direction separating from the plate 31. Therefore, the rotating body 5 receives a biasing force in a direction that the projections 5E, 5F of the rotating body 5 enter the grooves 60 of the column 6. Hence, when an external force is not acting on the rotating body 5, the rotating body 5 is held in the first position.

Next, a description of the cassette 1B when the rotating body 5 is positioned in the second position, will be given using FIG. 7. The cassette 1B is assumed to have been installed in the printing apparatus 1A at this time. That is, the rotating body 5 is assumed to be pressed in the direction approaching the plate 31, opposing the biasing force of the spring 4B, by the printing apparatus 1A, and thereby be positioned in the second position. As depicted in FIG. 7, in a state where the rotating body 5 is disposed in the second position, the grooves 60 of the column 6 are disposed in positions separated to the rear side from the projections 5E, 5F provided in the rotating body 5. The rods 56 of the projections 5E, 5F are not disposed on the insides of the grooves 60 of the column 6, so the rotating body 5 is enabled to rotate independently from the column 6. Therefore, the rotating body 5 disposed in the second position can be easily rotated with respect to the shaft 4A attached to the column 6.

<Method of Installing Ink Ribbon 9 in Cassette 1B>

A method of installing when the ink ribbon 9 is installed in the cassette 1B will be described. The ink ribbon 9 (refer to FIG. 4) in a state where both ends thereof have been respectively connected to the spools 9A, 9F (refer to FIG. 4) and the ribbon roll 90 (refer to FIG. 4) is held in the spool 9A, is installed in the cassette 1B (refer to FIG. 4) as follows. Note that as depicted in FIG. 6, the rotating body 5 moves in the direction separating from the plate 31 and is held in the first position, in response to the biasing force received from the spring 4B.

First, the user installs the spool 9A in the shaft 32A depicted in FIG. 4, and installs the spool 9F in the shaft 32F depicted in FIG. 4. The springs 5C, 5D of the rotating body 5 enter through-holes of the spools 9A, 9F while respectively deforming the two curved sections 55C, 55D to a main body 5A side. The two curved sections 55C, 55D each make firm and close contact from the inside with inner walls of the spools 9A, 9F due to stress on the two curved sections 55C, 55D. As a result, rotation of the spools 9A, 9F with respect to the rotating body 5 is restricted. Front ends of each of the spools 9A, 9F and the ribbon roll 90 abut, from the rear side, on the plate portion 57 of the pedestal 5B of the rotating body 5. As a result, the spool 9A and the ribbon roll 90 are positioned with respect to the shaft 32A, and the spool 9F is positioned with respect to the shaft 32F (refer to FIG. 4). Note that since the rotating body 5 is held in the first position, rotation of the rotating body 5 with respect to the shaft 4A is suppressed.

Next, the user guides the ink ribbon 9 onto the shafts 32B-32E. When the ink ribbon 9 is pulled out from the shaft 32A, the rotating body 5 rotates, in a state of being disposed in the first position (refer to FIG. 6), due to a force by which the ink ribbon 9 is pulled out. Because, as mentioned above, rotation of the rotating body 5 is suppressed, and, moreover, the ink ribbon 9 is applied with a back-tension, the user can easily guide the ink ribbon 9. The above results in a state where the ink ribbon 9 is stretched over the shafts 32B-32E, that is, a state of there being no slack in the ink ribbon 9.

<Printing Operation Due to Printing Apparatus 1A>

The user grips the handle 30 (refer to FIG. 1) of the cassette 1B in which the ink ribbon 9 is supported, and moves the cassette 1B that has been disposed on the front side of the printing apparatus 1A, to the rear side, in a sliding manner. As a result, the cassette 1B is inserted inside the casing 12 via the opening on the front side of the casing 12. The shafts 32 of the cassette 1B are engaged with the installing sections 22 of the printing apparatus 1A. The two projections 52 of the shafts 32A, 32F fit in the holes 220 of the installing sections 22A, 22F of the printing apparatus 1A. The respective rotating bodies 5 of the shafts 32A, 32F are enabled to rotate in response to rotation of the motors M of the printing apparatus 1A. A portion stretched across between the shafts 32C, 32D of the ink ribbon 9 of the cassette 1B is contacted from the upper side by the thermal head 26 of the printing apparatus 1A. As depicted in FIG. 1, the plate 31 of the cassette 1B covers the opening on the front side of the casing 12 of the printing apparatus 1A.

In a state where the cassette 1B has been installed in the printing apparatus 1A, the rotating bodies 5 of the shafts 32A, 32F receive from the installing sections 22A, 22F a force in a direction approaching the plate 31. The rotating bodies 5 move from the first position (refer to FIG. 6) to the second position (refer to FIG. 7), and attain a state where they can be rotated.

The printing apparatus 1A rotates the rotating bodies 5 of the cassette 1B by drive of the motors M. The ink ribbon 9 is fed out from the ribbon roll 90 of the cassette 1B, and moves between the shafts 32B-32E. The thermal head 26 heats the portion stretched across between the shafts 32C, 32D, of the ink ribbon that has been fed out from the ribbon roll 90. Ink of the ink ribbon 9 is transferred to the printing medium that has been disposed on the lower side of the printing apparatus 1A, by heating. The ink ribbon 9 that has undergone heating is wound onto the spool 9E

[Main Actions and Advantages of Present Embodiment]

The cassette 1B includes the plate 31, the shaft 4A, the rotating body 5, the spring 4B, the column 6, the rod 8A and head 8B of the shoulder bolt 8, the projections 5E, 5F, and the spring washer 7B. The shaft 4A is provided to the plate 31. The shaft 4A extends in a direction intersecting the plate 31. The hole 43A is formed in the end surface of the tip 43 of the shaft 4A. The rotating body 5 is provided at least partly around the shaft 4A. The rotating body 5 is capable of rotating around the shaft 4A. The spring 4B is provided between the plate 31 and the rotating body 5. The spring 4B biases the rotating body 5 in a direction separating from the plate 31. The column 6 is provided to the tip 43 of the shaft 4A. The column 6 includes the first bottom surface 61, the second bottom surface 62, the side surface 63, the through-hole 64, and the grooves 60. The distance between the first bottom surface 61 and the plate 31 is the first distance L11. The distance between the second bottom surface 62 and the plate 31 is the second distance L12 which is smaller than the first distance L11. The through-hole 64 penetrates between the first bottom surface 61 and the second bottom surface 62. The grooves 60 are provided in the side surface 63. The grooves 60 are formed by the first wall 65A and the second wall 65B that extend from the second bottom surface 62 toward the first bottom surface 61 and face each other. The rod 8A of the shoulder bolt 8 is inserted in the through-hole 64 of the column 6 and the hole 43A of the shaft 4A, and thereby attaches the column 6 to the shaft 4A. The head 8B is provided on an opposite side to the shaft 4A of the rod 8A. The projections 5E, 5F are provided in the rotating body 5. The rods 56 of the projections 5E, 5F project toward the rotational center 5X of the rotating body 5. The projections 5E, 5F are capable of entering inside the grooves 60. The projections 5E, 5F are capable of abutting on the first wall 65A and the second wall 65B of the column 6. The spring washer 7B is provided between the first bottom surface 61 of the column 6, and the head 8B.

In the cassette 1B, the column 6 is pressed against the end surface of the tip 43 of the shaft 4A, due to the biasing force of the spring washer 7B. The frictional force between the shaft 4A and the column 6 makes it difficult for the column 6 to rotate with respect to the shaft 4A. Moreover, in a state where the projections 5E, 5F provided in the rotating body 5 have been inserted in the grooves 60 of the column 6, rotation of the rotating body 5 with respect to the column 6 is restricted. In other words, in a state where the projections 5E, 5F provided in the rotating body 5 have been inserted in the grooves 60 of the column 6, it becomes difficult for the rotating body 5 to rotate with respect to the shaft 4A. Therefore, the cassette 1B can suppress rotation of the rotating body 5 in the case where the ribbon roll 90 having the ink ribbon 9 wound therein is installed in the rotating body 5. Hence, the user can easily perform guide work of the ink ribbon 9 during installation of the ink ribbon 9 in the cassette 1B.

The space between the first wall 65A and the second wall 65B of the column 6 gets larger as the second bottom surface 62 is approached. In this case, in the process of the rotating body 5 moving from the second position toward the first position, the rods 56 of the projections 5E, 5F are guided by the first wall 65A and the second wall 65B and are easily inserted in the grooves 60. Therefore, in the cassette 1B, the projections 5E, 5F can be easily switched from a state of not being inserted in the grooves 60 to a state of being inserted in the grooves 60.

The space between the first wall 65A and the second wall 65B of the column 6 gets continuously larger as the second bottom surface 62 is approached. In this case, the projections 5E, 5F can be smoothly inserted inside the grooves 60.

The first wall 65A and the second wall 65B are joined at the end section 65C positioned between the first bottom surface 61 and the second bottom surface 62. When the projections 5E, 5F have entered the grooves 60 and the projections 5E, 5F have abutted on the first wall 65A and the second wall 65B, the projections 5E, 5F are positioned between the end section 65C and the second bottom surface 62. A gap is formed between the projections 5E, 5F and the end section 65C. When the rods 56 of the projections 5E, 5F have been inserted in the grooves 60, the rods 56 abut on the first wall 65A and the second wall 65B at the certain positions 653A, 653B of the grooves 60. Therefore, the rods 56 of the projections 5E, 5F can be abutted on both the first wall 65A and the second wall 65B of the column 6, even when variation has occurred in spacing of the grooves 60 due to individual differences.

The spring washer 7B functions as an elastic body. In other words, the spring washer 7B can absorb an impact received from the column 6 by the second portion 82 of the rod 8A and an impact received by the grooves 60 from the rods 56 of the projections 5E, 5F when the rods 56 of the projections 5E, 5F have been inserted in the grooves 60.

The cassette 1B further includes the flat washer 7A between the first bottom surface 61 of the column 6 and the head 8B. In this case, the flat washer 7A can reduce abrasion of the column 6 due to the column 6 rotating with respect to the shaft 4A and the rod 8A.

The shoulder bolt 8 is configured by the rod 8A and the head 8B. The rod 8A includes the first portion 81, the second portion 82, and the third portion 83. A screw thread is formed in the side surface of the first portion 81. The first portion 81 is inserted in the hole 43A of the shaft 4A. The second portion 82 is disposed between the head 8B and the first portion 81. The diameter R22 of the second portion 82 is larger than the diameter R21 of the first portion 81 and smaller than the diameter R41 of the shaft 4A. The end surface 86 on the opposite side to the head 8B, of the second portion 82 abuts on the end surface of the tip 43 of the shaft 4A. The third portion 83 is disposed between the first portion 81 and the second portion 82. The third portion 83 is inserted in the hole 43A of the shaft 4A. The diameter R23 of the third portion 83 is smaller than the diameter R21 of the first portion 81. In this case, a region held by the column 6 is secured between the head 8B and the shaft 4A in a state where the first portion 81 of the rod 8A has been screwed into the hole 43A of the shaft 4A. Therefore, an assembly step by which the column 6 is held in the shaft 4A by the shoulder bolt 8, can be made easy.

The main body 5A of the rotating body 5 has a cylindrical shape. The shaft 4A is inserted in the cavity 51A of the main body 5A of the rotating body 5. In this case, the rotating body 5 can support the entire inner side of the installed spools 9A, 9F. Therefore, the rotating body 5 can stably hold the ribbon roll 90 that has the ribbon wound therein.

The printing apparatus 1A includes the installing sections 22, the motors M, and the thermal head 26. The cassette 1B is installed in the installing sections 22. The motors M rotate the rotating bodies 5 in a state where the cassette 1B has been installed in the installing sections 22. The thermal head 26 heats the ink ribbon 9 that has been fed out from the cassette 1B in response to the rotating bodies 5 being rotated by the motors M. In this case, guiding of the ink ribbon 9 to the cassette 1B becomes easy. Hence, the cassette 1B is installed in the printing apparatus 1A in a state where the ink ribbon has been firmly guided onto the shafts 32B-32E, that is, in a state where the ink ribbon 9 has been firmly tensioned between the shafts 32B-32E. Therefore, it is possible to reduce a risk of the ink ribbon 9 interfering with a member of the printing apparatus 1A, such as, for example, the thermal head 26, and so on, whereby installation of the cassette 1B is hindered. Moreover, the printing apparatus 1A enables slack of the ink ribbon 9 to be suppressed, so a possibility of, for example, the ink ribbon 9 becoming charged, and the ink ribbon 9 being attracted to the printing medium by static electricity during the printing operation, can be reduced.

### Modified Examples

The present teaching is not limited to the above-described embodiment, and may undergo a variety of changes. The direction that the shaft 4A extends with respect to the plate 31 is not limited to a direction orthogonally intersecting the plate 31. The shaft 4A may extend in a slanted direction with respect to the direction orthogonally intersecting the plate 31. The shaft 4A need not be fixed with respect to the plate 31. In this case, for example, the shaft 4A may be rotatable at a certain angle with respect to the plate 31. Moreover, for example, the shaft 4A may be movable in at least any one direction of the up-down direction and the left-right direction, with respect to the plate 31. The main body 5A of the rotating body 5 may have a shape other than a cylindrical shape. For example, a plurality of through-holes may be provided in a side surface of the main body 5A of the rotating body 5. In this case, the main body 5A may be provided so as to only partly cover around the shaft 4A. Furthermore, when the main body 5A has a shape other than a cylindrical shape, the cavity 51A need not be provided. In this case, the shaft 4A need not be inserted in the cavity 51. The height of the column 6 may be longer than the diameter of the column 6, or the height and diameter of the column 6 may be identical.

The shoulder bolt 8 need only include the first portion 81 and the second portion 82, and need not include the third portion 83. Another member having a rod and a head may be employed instead of the shoulder bolt 8. A member not having a screw thread formed therein, for example, an interference fit, may be employed as the rod.

The first wall 65A and the second wall 65B forming the grooves 60 need not be plane surfaces, but may each be curved convexly toward the inside of the grooves 60 or may each be curved convexly toward the outside of the grooves 60. Even in this case, the space between the first wall 65A and the second wall 65B may get continuously larger as the second bottom surface 62 is approached. The first wall 65A and the second wall 65B may be joined on a first bottom surface 61 side.

Steps may be provided in each of the first wall 65A and the second wall 65B. For example, there may be provided in each of the first wall 65A and the second wall 65B at least first steps parallel to the front-rear direction passing through the places 651A, 651B, second steps parallel to the front-rear direction passing through the certain positions 653A, 653B, and third steps parallel to the front-rear direction passing through the ends 652A, 652B. The space between the first wall 65A and the second wall 65B may get larger in a discontinuous manner as the second bottom surface 62 is approached. Furthermore, the first wall 65A and the second wall 65B forming the grooves 60 may each extend in parallel with the front-rear direction, from the second bottom surface 62 toward the first bottom surface 61. The space between the first wall 65A and the second wall 65B may be uniform spanning from the places 651A, 651B on the first bottom surface 61 side to the ends 652A, 652B.

The width L22 between the one end 56A and the other end 56B of the rods 56 of the projections 5E, 5F may be smaller than the space L21 between the places 651A, 651B on the first bottom surface 61 side. In this case, the rods 56 of the projections 5E, 5F may abut on the end section 65C in a state of having been disposed in the groove 60B. A gap need not be formed between the rod 56 and the end section 65C. The radius R12 of the arc 651 may be larger than a radius R11 of the rod 56 of the projection 5E.

The flat washer 7A is not limited to being made of a resin, and may be formed by another material. The flat washer may be provided between the second bottom surface 62 of the column 6 and the shaft 4A. The flat washer 7A need not be provided. The spring washer 7B is not limited to being made of a metal, and may be formed by another material. The spring washer may be provided between the second bottom surface 62 of the column 6 and the shaft 4A. Another elastic body (for example, rubber, or the like) may be employed instead of the spring washer.

The method of installing the ink ribbon 9 in the cassette 1B is not limited to the method described in the above-described embodiment. For example, the ink ribbon 9 may be installed in the cassette 1B as follows. First, the user installs in the shaft 32A the spool 9A in which the ribbon roll 90 is held. Note that the rotating body 5 of the shaft 32A is held in the first position, and rotation of the rotating body 5 with respect to the shaft 4A is suppressed. Next, the user pulls out the ink ribbon 9 from the ribbon roll 90 by separating the spool 9B from the spool 9A. At the same time, the user guides the pulled out ink ribbon 9 onto the shafts 32B-32E by moving the spool 9B so as to surround the shafts 32B-32E from the outside. Note that since rotation of the rotating body 5 is suppressed, the ink ribbon 9 is stretched across between the shafts 32B-32E in a state of having been applied with a back-tension. As a result, the user can easily guide the ink ribbon 9 between the shafts 32B-32E without causing slack in the ink ribbon 9. Finally, the user installs the spool 9B in the shaft 32E Note that the rotating body 5 of the shaft 32F is held in the first position, and rotation of the rotating body 5 with respect to the shaft 4A is suppressed. Therefore, a state of the ink ribbon 9 being stretched across with no slack is maintained even after the spool 9B has been installed in the shaft 32F.

### Second Embodiment

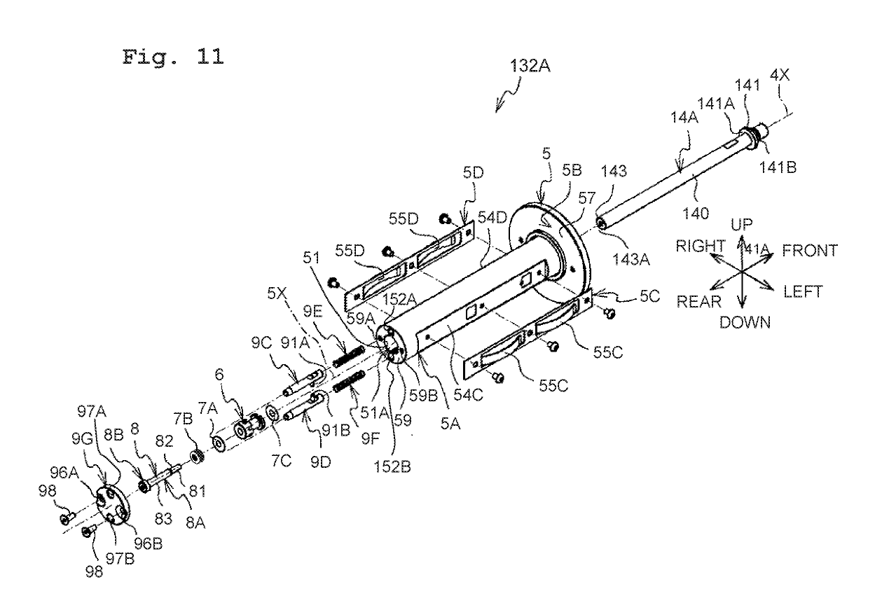

A second embodiment of the present teaching will be described with reference to FIGS. 11 to 18. In the second embodiment, configurations of shafts 132A, 132F are different from the first embodiment.

<Shafts 132A, 132F>

The shafts 132A, 132F have identical configurations. Hereafter, the shaft 132A will be specifically described as an example, and description of the shaft 132F will be omitted. As depicted in FIG. 11, the shaft 132A includes the likes of a shaft 14A, a rotating body 5, a column 6, flat washers 7A, 7C, a spring washer 7B, a shoulder bolt 8, the second rods 9C, 9D, springs 9E, 9F, and a cover 9G.

<Shaft 14A>

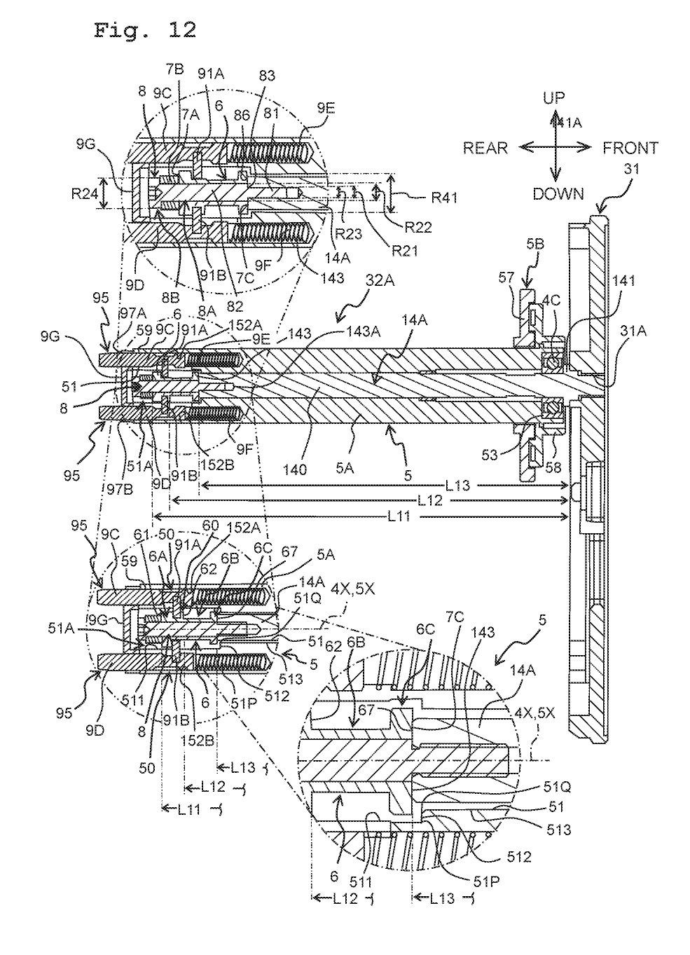

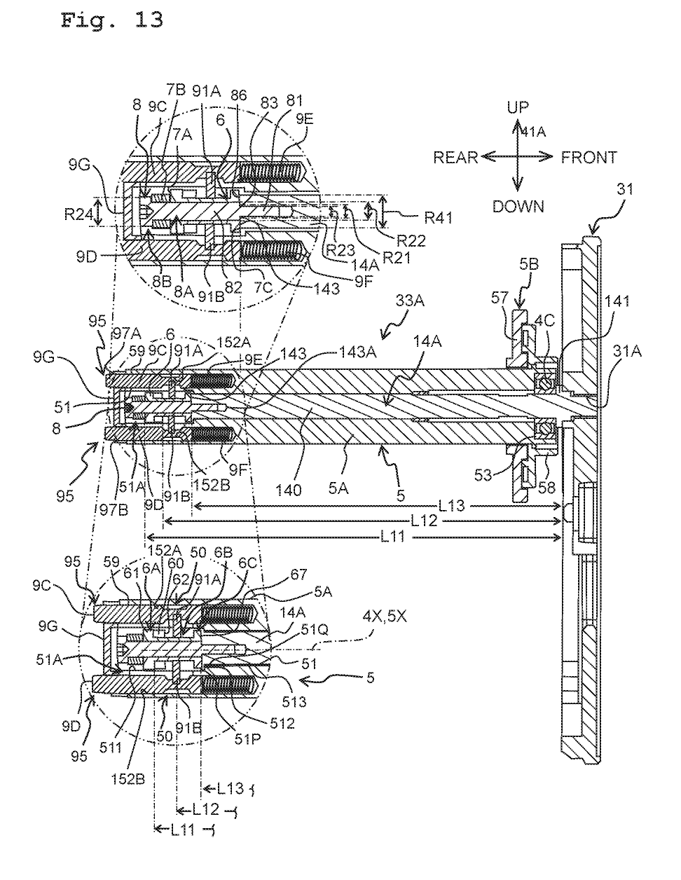

The shaft 14A has a main body 140 and a fourth projection 141. As depicted in FIGS. 12 and 13, the shaft 14A is provided to the plate 31. The main body 140 has substantially a circular columnar shape. The main body 140 extends to the rear side from a rear surface of the plate 31. An extending direction of the main body 140 is orthogonal to the plate 31. A front end of the main body 140 fits in a hole 31A provided in the rear surface of the plate 31. Rotation of the shaft 14A with respect to the plate 31 is restricted. As depicted in FIG. 11, a virtual axis passing along a center of the main body 140 is defined as a “reference axis 4X”. The reference axis 4X extends in the front-rear direction.

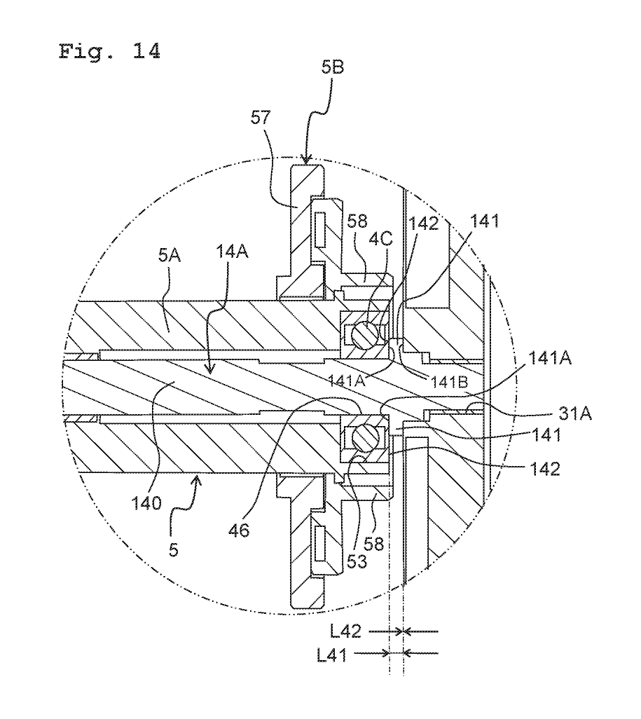

The shaft 14A has the fourth projection 141 more to the rear side than a portion fitting in the hole 31A (refer to FIGS. 12 and 13), of the front end of the main body 140. The fourth projection 141 projects from a side surface of the main body 140. An extending direction of the fourth projection 141 is orthogonal to the reference axis 4X. As depicted in FIG. 14, the fourth projection 141 has a fourth surface 141A and a fifth surface 141B that are orthogonal to the reference axis 4X. The fourth surface 141A faces the rear side, and the fifth surface 141B faces the front side. The fifth surface 141B contacts the rear surface of the plate 31 from the rear side. Movement to the front side of the shaft 14A with respect to the plate 31 is restricted by the fifth surface 141B of the fourth projection 141 contacting the rear surface of the plate 31. A distance L42 between the fifth surface 141B and the rear surface of the plate 31 is zero. A distance L41 between the fourth surface 141A and the rear surface of the plate 31 is a thickness of the fourth projection 141, and is larger than the distance L42.

As depicted in FIG. 11, a hole 143A recessing toward the front side is formed in an end surface of a rear end of the main body 140 of the shaft 14A (hereafter, this rear end will be referred to as a “tip 143 of the shaft 14A”). A cross-sectional shape of the hole 143A is circular. The hole 143A extends along the reference axis 4X. A screw thread is formed in an inner wall of the hole 143A. The shoulder bolt 8 is screwed into the hole 143A.

<Rotating Body 5>

As depicted in FIG. 11, the rotating body 5 includes a main body 5A, a pedestal 5B, and plate springs 5C, 5D. The rotating body 5 has a cylindrical shape. The main body 5A has a cylindrical shape. Two bottom surfaces of the main body 5A face each other in the front-rear direction. The main body 5A has a through hole 51 that extends so as to span between the two bottom surfaces. A cross-sectional shape of the through-hole 51 is circular. A diameter of the through-hole 51 is substantially identical to a diameter of the shaft 14A. Hereafter, a space enclosed by the through-hole 51 will be referred to as a “cavity 51A”. The cavity 51A extends toward the plate 31 from an end section opposite to the plate 31 of the main body 5A (hereafter, this end section will be referred to as a “tip 59 of the rotating body 5”). As depicted in FIG. 12, the cavity 51A is formed by a first surface 511, a second surface 512, and a third surface 513 of the through-hole 51. The first surface 511 extends along the reference axis 4X toward the plate 31 from the tip 59 of the rotating body 5, to a first boundary position 51P. The second surface 512 extends along a direction orthogonal to the reference axis 4X toward the reference axis 4X from the first boundary position 51P, to a second boundary position 51Q. The third surface 513 extends along the reference axis 4X toward the plate 31 from the second boundary position 51Q. A diameter of the through-hole 51 in the first surface 511 is larger than a diameter of the through-hole 51 in the third surface 513. A step is formed in the through-hole 51 by the first boundary position 51P and the second boundary position 51Q.

As depicted in FIG. 11, holes 152A, 152B recessing to the front side are provided in an end surface of the tip 59 of the rotating body 5. The holes 152A, 152B are circular in cross-sectional shape, and are disposed in facing positions sandwiching the through-hole 51, of the main body 5A. The holes 152A, 152B extend along the reference axis 4X toward the plate 31 from the tip 59 of the rotating body 5. Portions adjacent to the reference axis 4X, of the holes 152A, 152B are connected to the through-hole 51. As depicted in FIGS. 12 and 13, the bottom surface on the front side of the main body 5A is provided with a hole 53 that recesses to the rear side. A cross-sectional shape of the hole 53 is circular. A front end of the through-hole 51 communicates with a bottom surface of the hole 53. The hole 53 is fitted with a bearing 4C. As depicted in FIG. 14, a through-hole 46 of the bearing 4C extends in the front-rear direction. As depicted in FIG. 14, a surface facing the plate 31, of the bearing 4C is referred to as a “sixth surface 142”. The sixth surface 142 corresponds to a surface facing the plate 31, of the rotating body 5.

As depicted in FIGS. 12 and 13, the shaft 14A is inserted in the cavity 51A. In this case, the main body 5A is disposed so as to cover an entire region around the shaft 14A. The bearing 4C bears a shaft that has been inserted in the cavity 51A. As depicted in FIG. 14, part of the sixth surface 142 of the bearing 4C contacts from the rear the fourth surface 141A of the fourth projection 141 of the shaft 14A. As a result, movement in a frontward direction of the rotating body 5 with respect to the shaft 14A is restricted, and the rotating body 5 is positioned with respect to the shaft 14A. The main body 5A is capable of rotating around the shaft 14A that has been inserted in the cavity 51A. As depicted in FIG. 11, a rotational center in the case that the main body 5A of the rotating body 5 rotates, is referred to as a “rotational center 5X”. The rotational center 5X coincides with the reference axis 4X of the shaft 14A in a state where the shaft 14A has been inserted in the cavity 51A. In other words, the rotating body 5 is capable of rotating around the shaft 14A centering on the reference axis 4X of the shaft 14A. The bearing 4C reduces friction between the shaft 14A and the main body 5A during rotation of the main body 5A.

As depicted in FIG. 11, a plane surface 54C is provided at a left end of a side surface of the main body 5A, and a plane surface 54D is provided at a right end of the side surface of the main body 5A. The plane surfaces 54C, 54D are each formed by part of the side surface of the main body 5A being cut out. A plurality of through-holes penetrating into the cavity 51A are provided in the plane surfaces 54C, 54D. The plate spring 5C is fixed to the plane surface 54C by a plurality of raised countersunk head screws being screwed into the plurality of through-holes of the plane surface 54C. The plate spring 5D is fixed to the plane surface 54D by a plurality of raised countersunk head screws being screwed into the plurality of through-holes of the plane surface 54D. The plate springs 5C, 5D have an identical shape. The plate spring 5C has two curved sections 55C that curve convexly toward an opposite side to the main body 5A (toward the left side). The plate spring 5D has two curved sections 55D that curve convexly toward an opposite side to the main body 5A (toward the right side).

The pedestal 5B is fixed to a front end of the main body 5A. The pedestal 5B has a plate portion 57 and a cylinder portion 58 (refer to FIGS. 12 and 13). The plate portion 57 has a circular plate-like shape, and is orthogonal to the rotational center 5X. The front end of the main body 5A is inserted in a through-hole provided in a center of the plate portion 57. As depicted in FIGS. 12 and 13, the cylinder portion 58 is provided in a front surface of the plate portion 57, and is fixed to the front end of the main body 5A. A diameter of the through-hole of the cylinder portion 58 is larger than a diameter of the main body 5A.

<Second Rods 9C, 9D>

As depicted in FIG. 11, the second rods 9C, 9D are each provided to the rotating body 5. The second rods 9C, 9D each have substantially a circular columnar shape. The second rod 9C is inserted from the rear side in the hole 152A of the rotating body 5. The second rod 9C extends in parallel with the rotational center 5X along the hole 152A. The second rod 9D is inserted from the rear side in the hole 152B of the rotating body 5. The second rod 9D extends in parallel with the rotational center 5X along the hole 152B. As depicted in FIGS. 12 and 13, a resin 50 for lubrication is provided to each of between the second rod 9C and a wall surface of the hole 152A and between the second rod 9D and a wall surface of the hole 152B. As depicted in FIGS. 12 and 13, a part including a rear end of the second rods 9C, 9D (hereafter, this rear end will be referred to as a “tip of the second rods 9C, 9D”) projects to the rear from the tip 59 of the rotating body 5. Hereafter, a portion that is the part including the tip of the second rods 9C, 9D and that projects from the tip 59 of the rotating body 5, will be referred to as the “projecting section 95”. The projecting section 95 is applied with a taper. A diameter of the projecting section 95 gets smaller the more respective tips of the second rods 9C, 9D are neared.

The second rod 9C is capable of moving in a direction parallel to the rotational center 5X along the hole 152A. The second rod 9D is capable of moving in the direction parallel to the rotational center 5X along the hole 152B. FIG. 12 depicts a state where the second rods 9C, 9D have moved in a rearward direction with respect to the rotating body 5. FIG. 13 depicts a state where the second rods 9C, 9D have moved in a frontward direction with respect to the rotating body 5. Hereafter, a position of the second rods 9C, 9D depicted in FIG. 12 will be referred to as a “first position”, and a position of the second rods 9C, 9D depicted in FIG. 13 will be referred to as a “second position”.

The second rods 9C, 9D are positioned in the first position mainly when the cassette 1B is not installed in the printing apparatus 1A. Guiding of the ink ribbon 9 to the rotating body 5 by a user is performed mainly when the second rods 9C, 9D are positioned in the first position. The second rods 9C, 9D are positioned in the second position when the cassette 1B is installed in the printing apparatus 1A. The ink ribbon 9 is conveyed by rotation of the rotating body 5 and printing is executed when the second rods 9C, 9D are positioned in the second position.

<First Projections 91A, 91B>

As depicted in FIG. 11, a first projection 91A is provided to the second rod 9C. A first projection 91B is provided to the second rod 9D. The first projections 91A, 91B each have a circular columnar shape. The first projection 91A projects toward the rotational center 5X from the second rod 9C. The first projection 91A passes along a connecting portion of the through-hole 51 and the hole 152A. Part on a tip side of the first projection 91A is disposed inside the cavity 51A (refer to FIGS. 12 and 13). The first projection 91B projects toward the rotational center 5X from the second rod 9D. The first projection 91B passes along a connecting portion of the through-hole 51 and the hole 152B. Part on a tip side of the first projection 91B is disposed inside the cavity 51A (refer to FIGS. 12 and 13).

<Springs 9E, 9F>

As depicted in FIG. 11, the springs 9E, 9F are disposed inside the holes 152A, 152B of the rotating body 5. The springs 9E, 9F are each a cylindrical compression coil spring. As depicted in FIGS. 12 and 13, the spring 9E is disposed inside the hole 152A more to the front side than a front end of the second rod 9C. The spring 9E is sandwiched from both front and rear sides by a bottom section of the hole 152A and the second rod 9C. A biasing force acting on the second rod 9C from the spring 9E acts in a direction of separating from the plate 31, that is, in the rearward direction. The spring 9F is disposed inside the hole 152B more to the front side than a front end of the second rod 9D. The spring 9F is sandwiched from both front and rear sides by a bottom section of the hole 152B and the second rod 9D. Biasing force acting on the second rod 9D from the spring 9F acts in a direction of separating from the plate 31, that is, in the rearward direction.

The second rods 9C, 9D move in the direction of separating from the plate 31 and are held in the first position (refer to FIG. 12), in response to the biasing force received from the springs 9E, 9E On the other hand, when an external force in the frontward direction acts on the second rods 9C, 9D, the second rods 9C, 9D move in a direction of approaching the plate 31 and are held in the second position (refer to FIG. 13), opposing the biasing force of the springs 9E, 9E

<Column 6>

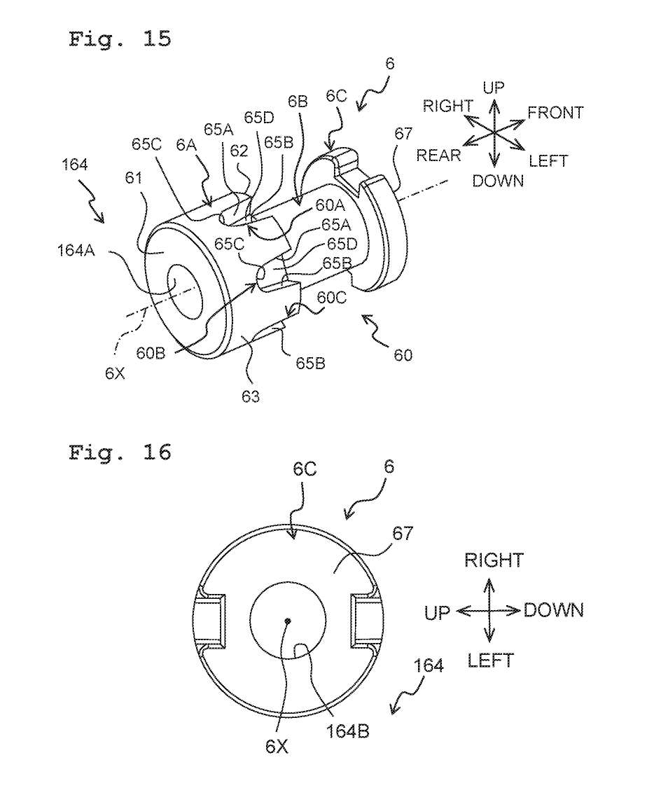

As depicted in FIGS. 12 and 13, the column 6 is disposed inside the cavity 51A of the rotating body 5. The column 6 is provided to the tip 143 of the shaft 14A. The column 6 is attached to the shaft 14A by the shoulder bolt 8. As depicted in FIG. 15, the column 6 has a circular column 6A and a cylinder 6B. The cylinder 6B and the circular column 6A are aligned in the front-rear direction in this order.

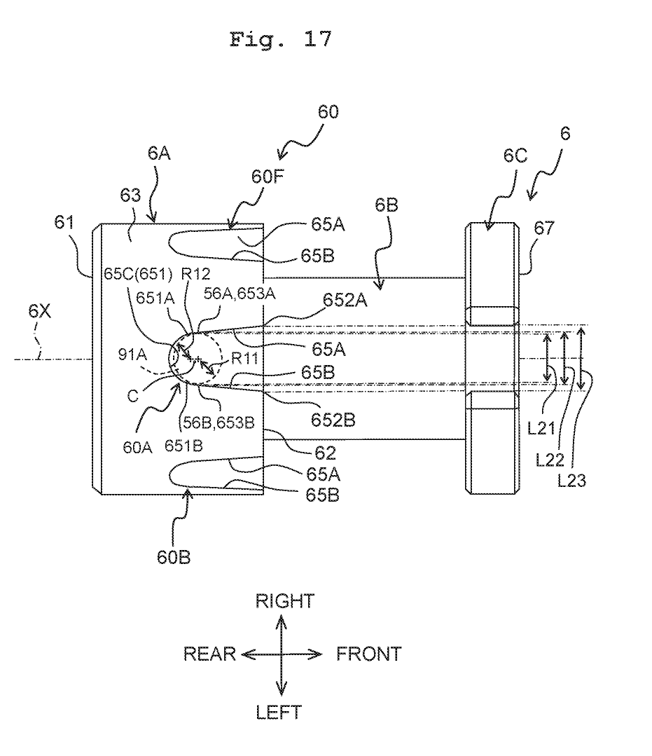

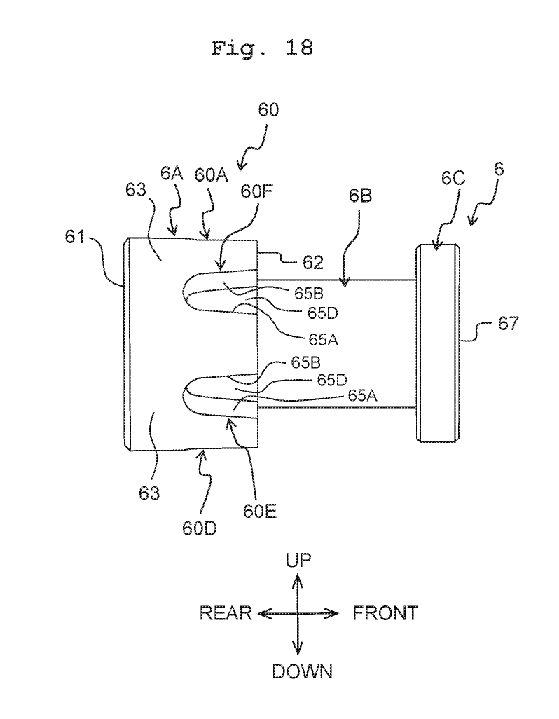

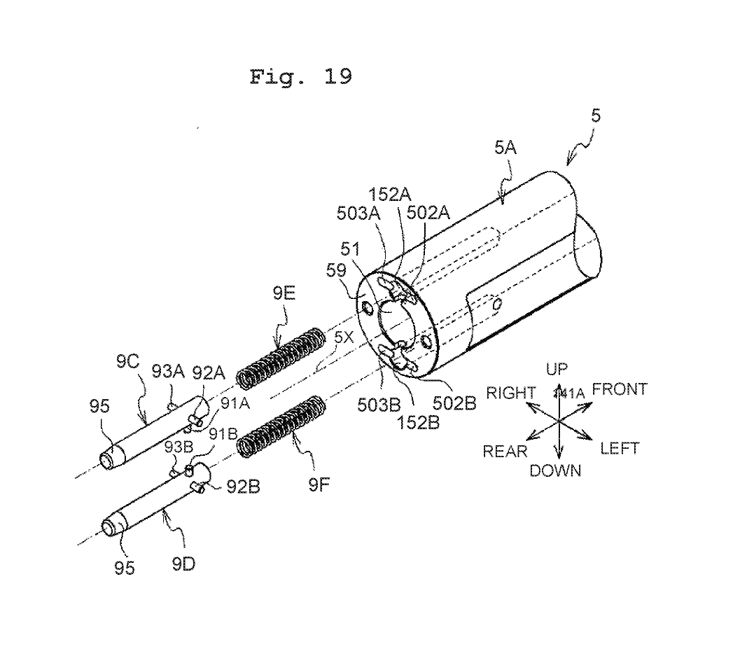

As depicted in FIG. 15, a height of the circular column 6A is shorter than a diameter of the circular column 6A. The circular column 6A includes a first bottom surface 61, a second bottom surface 62, a side surface 63, a through-hole 164A, and grooves 60A, 60B, 60C (refer to FIG. 15), 60D, 60E, 60F (refer to FIG. 18). As depicted in FIGS. 17 and 18, the first bottom surface 61 and the second bottom surface 62 face each other in the front-rear direction. The first bottom surface 61 is disposed to the rear side of the second bottom surface 62. As depicted in FIGS. 12 and 13, a distance between the rear surface of the plate 31 and the first bottom surface 61 is defined as a “first distance L11”, and a distance between the rear surface of the plate 31 and the second bottom surface 62 is defined as a “second distance L12”. In this case, the second distance L12 is smaller than the first distance L11. As depicted in FIG. 15, the through-hole 164A penetrates between the first bottom surface 61 and the second bottom surface 62. Hereafter, a virtual axis extending in the front-rear direction passing along a center of the through-hole 164A will be referred to as a “reference axis 6X”.

As depicted in FIGS. 15, 17, and 18, the grooves 60A, 60B, 60C, 60D, 60E, 60F are provided in the side surface 63 of the circular column 6A. The grooves 60A-60F are arranged at equal intervals in a circumferential direction of the side surface 63. The grooves 60A-60F have an identical shape. Each of the groove 60A and groove 60D, the groove 60B and groove 60E, and the groove 60C and groove 60F face each other sandwiching the through-hole 164A. Hereafter, when the grooves 60A-60F are not distinguished, they will be referred to collectively as “grooves 60”.

The grooves 60 are formed by a first wall 65A, a second wall 65B, and a third wall 65D that are provided in the side surface 63 of the circular column 6A. The first wall 65A, the second wall 65B, and the third wall 65D each extend from the second bottom surface 62 toward the first bottom surface 61. The first wall 65A and the second wall 65B are each plane surfaces, and each intersect the circumferential direction of the side surface 63. The first wall 65A and the second wall 65B each extend from the side surface 63 toward the through-hole 164A. The first wall 65A and the second wall 65B face each other. The third wall 65D is a plane surface, and is orthogonal to a radial direction centered on the reference axis 6X. The third wall 65D is positioned between the side surface 63 and the through-hole 164A in a direction orthogonal to the reference axis 6X. The third wall 65D is connected to ends closest to the through-hole 164A, of each of the first wall 65A and the second wall 65B.

As depicted in FIG. 17, the first wall 65A and the second wall 65B each extend in a direction slanting with respect to a direction (the front-rear direction) that the first bottom surface 61 and the second bottom surface 62 face each other. A space between the first wall 65A and the second wall 65B gets larger as the second bottom surface 62 is approached from the first bottom surface 61. The space between the first wall 65A and the second wall 65B gets continuously larger as the second bottom surface 62 is approached from the first bottom surface 61. That is, the space between the first wall 65A and the second wall 65B gets continuously smaller as the first bottom surface 61 is approached from the second bottom surface 62. The first wall 65A and the second wall 65B curve from, respectively, a place 651A and a place 651B along the way of approaching the first bottom surface 61 from the second bottom surface 62, and thereby form an arc 651. Moreover, the first wall 65A and the second wall 65B are joined at a joining section 65C. The joining section 65C is positioned between the first bottom surface 61 and the second bottom surface 62 in a direction parallel to the reference axis 6X. Since, as mentioned above, the space between the first wall 65A and the second wall 65B gets (continuously) larger as the second bottom surface 62 is approached from the first bottom surface 61, then, for example, a space L23 between an end 652A on a second bottom surface 62 side of the first wall 65A and an end 652B on a second bottom surface 62 side of the second wall 65B is larger than a space L21 between the place 651A of the first wall 65A and the place 651B of the second wall 65B.

There is defined a virtual axis C that passes through a certain position of the third wall 65D, of a virtual axis extending in a radial direction centering on the reference axis 6X. In this case, the arc 651 is part of a circle of radius R12 centered on the virtual axis C.

As depicted in FIG. 15, the cylinder 6B extends from the second bottom surface 62 of the circular column 6A toward the tip 143 of the shaft 14A (refer to FIG. 11). A projecting section 6C is provided to an end section opposite to the circular column 6A of the cylinder 6B. The projecting section 6C projects in the radial direction centered on the reference axis 6X, from a side surface of the cylinder 6B. A diameter of the projecting section 6C is larger than a diameter of the end surface of the tip 143 of the shaft 14A. A bottom surface at a front end of the projecting section 6C is referred to as a “third bottom surface 67”.

The cylinder 6B has a through-hole 164B (refer to FIG. 16). The through-hole 164B extends along the reference axis 6X. A rear end of the through-hole 164B is connected to a front end of the through-hole 164A of the circular column 6A. The through-holes 164A, 164B are integrated to form a through-hole 164 in the column 6. The through-hole 164 penetrates between the first bottom surface 61 and the third bottom surface 63. As depicted in FIGS. 12 and 13, a distance between the rear surface of the plate 31 and the third bottom surface 67 is defined as a “third distance L13”. The third distance L13 is smaller than the second distance L12.

As depicted in FIG. 12, one portion in the radial direction centered on the reference axis 6X, of the third bottom surface 67 contacts the end surface of the tip 143 of the shaft 14A. Moreover, another portion on an outer side in the radial direction centered on the reference axis 6X, of the projecting section 6C projects more to the outer side than a side surface of the shaft 14A, and is capable of contacting the second surface 512 of the through-hole 51.

Movement in the rearward direction of the rotating body 5 is suppressed by the third bottom surface 67 of the column 6 being contacted from the front by the second surface 512. Moreover, movement in the frontward direction of the rotating body 5 with respect to the shaft 14A is restricted by the sixth surface 142 of the rotating body 5 contacting from the rear the fourth surface 141A of the fourth projection 141 of the shaft 14A. Therefore, a position in the front-rear direction of the rotating body 5 is positioned in a range that movement is allowed by the above. Furthermore, since movement in the rearward direction of the rotating body 5 is suppressed as described above, detachment of the rotating body 5 from the shaft 14A is suppressed.

As depicted in FIG. 13, when the second rods 9C, 9D have moved in a direction parallel to the rotational center 5X with respect to the column 6, whereby the second rods 9C, 9D have been disposed in the second position, the grooves 60 are disposed in positions separated to the rear side from the first projections 91A, 91B. In a process of the second rods 9C, 9D moving from the second position to the first position (refer to FIG. 12), the first projections 91A, 91B respectively enter from the front side two of the grooves 60 facing each other sandwiching the through-hole 164 (refer to FIG. 15). As depicted in FIG. 12, when the second rods 9C, 9D have been disposed in the first position, the first projections 91A, 91B are disposed on the respective insides of the two grooves 60 facing each other sandwiching the through-hole 164.

As depicted in FIG. 17, in a state where, for example, the first projection 91A is disposed in the groove 60A, a one end 56A of the first projection 91A abuts on a certain position 653A of the first wall 65A, and an other end 56B of the first projection 91A abuts on a certain position 653B of the second wall 65B. The certain position 653A and the certain position 653B are positioned between the first bottom surface 61 and the second bottom surface 62 in the front-rear direction. The certain position 653A is disposed more to a second bottom surface 62 side than the place 651A, and is positioned more to a first bottom surface 61 side than the end 652A on the second bottom surface 62 side of the first wall 65A. The certain position 653B is disposed more to a second bottom surface 62 side than the place 651B on the first bottom surface 61 side of the second wall 65B, and is positioned more to a first bottom surface 61 side than the end 652B on the second bottom surface 62 side of the second wall 65B. The first projection 91A does not abut on the joining section 65C. That is, a gap is formed between the first projection 91A and the joining section 65C.

A width L22 between the one end 56A and the other end 56B is identical to a space between the certain positions 653A, 653B. The space L21 between the places 651A, 651B is smaller than the width L22. The space L23 between the ends 652A, 652B on a second bottom surface 62 side is larger than the width L22.

<Shoulder Bolt 8>

The shoulder bolt 8 holds in the tip 143 of the shaft 14A, the column 6, the flat washers 7A, 7C, and the spring washer 7B. As depicted in FIG. 11, the shoulder bolt 8 is configured by a first rod 8A and a head 8B. The head 8B is provided to a rear end of the first rod 8A. The head 8B has a larger diameter than the first rod 8A. In other words, the head 8B is larger than the first rod 8A in a direction orthogonal to the rotational center 5X.

The first rod 8A is inserted in the through-hole 164 (refer to FIGS. 15 and 16) of the column 6 and the hole 143A of the shaft 14A, and attaches the column 6 to the tip 143 of the shaft 14A. The first rod 8A extends in the front-rear direction. As depicted in FIGS. 12 and 13, the first rod 8A has a first portion 81, a second portion 82, and a third portion 83. The first portion 81, the second portion 82, and the third portion 83 each have a circular columnar shape and each extend in the front-rear direction. The first portion 81, the second portion 82, and the third portion 83 are disposed aligned in the front-rear direction. The first portion 81 is disposed in front of the third portion 83, and the second portion 82 is disposed behind the third portion 83. The third portion 83 is disposed between the first portion 81 and the second portion 82.

The first portion 81, the second portion 82, and the third portion 83 have respectively differing diameters. A diameter R21 of the first portion 81 is substantially identical to a diameter of the hole 143A of the shaft 14A. A diameter R22 of the second portion 82 is larger than the diameter R21. A diameter R23 of the third portion 83 is smaller than the diameter R21. The diameters R21, R22, R23 are smaller than a diameter R41 of the shaft 14A.

A screw thread is formed in a side surface of the first portion 81. The first portion 81 and the third portion 83 are inserted from the rear side in the hole 143A of the shaft 14A. The first rod 8A is fixed to the shaft 14A by the screw thread of the side surface of the first portion 81 being screwed into the screw thread of the inner wall of the hole 143A. The head 8B is connected to a rear end of the second portion 82. The first portion 81 is disposed in front of the second portion 82. The second portion 82 is disposed in front of the head 8B. The second portion 82 is disposed between the first portion 81 and the head 8B.

The head 8B is provided on an opposite side to the shaft 14A of the first rod 8A. A diameter R24 of the head 8B is larger than any of the diameters R21, R22, R23, R41. The reference axis 4X of the shaft 14A and the reference axis 6X of the column 6 coincide in a state where the column 6 has been attached to the shaft 14A by the shoulder bolt 8. Note that the rotational center 5X of the rotating body 5 coincides with the reference axis 4X of the shaft 14A in a state where the shaft 14A has been inserted in the cavity 51A of the rotating body 5. In other words, the reference axes 4X, 6X and the rotational center 5X coincide in a state where the shaft 14A has been inserted in the cavity 51A of the rotating body 5 and the column 6 has been attached to the shaft 14A.

<Flat Washers 7A, 7C and Spring Washer 7B>

As depicted in FIGS. 11, 12, and 13, the flat washer 7A and the spring washer 7B are provided between the first bottom surface 61 of the column 6 and the head 8B of the shoulder bolt 8. The flat washer 7A is made of a resin. The spring washer 7B is made of a metal. As depicted in FIGS. 12 and 13, the second portion 82 of the first rod 8A of the shoulder bolt 8 is inserted in a through-hole in a center of the spring washer 7B. The second portion 82 of the first rod 8A of the shoulder bolt 8 is inserted in a through-hole in a center of the flat washer 7A. By the first portion 81 of the first rod 8A of the shoulder bolt 8 being fixed to the shaft 14A, the flat washer 7A and the spring washer 7B are supported by the shaft 14A via the column 6. The flat washer 7A is disposed on a column 6 side of the spring washer 7B, and contacts the first bottom surface 61 (refer to FIG. 15). The spring washer 7B is disposed on an opposite side to the column 6 of the flat washer 7A, and contacts the head 8B. The flat washer 7A is pressed against the first bottom surface 61 (refer to FIGS. 15 and 16) of the column 6 by a biasing force of the spring washer 7B. The flat washer 7A is provided to suppress abrasion of the column 6.

The flat washer 7C is provided between the third bottom surface 67 of the column 6 and the end surface of the tip 143 of the shaft 14A. The flat washer 7C is made of a resin. The third portion 83 of the first rod 8A of the shoulder bolt 8 is inserted in a through-hole in a center of the flat washer 7C. An end surface 86 on an opposite side to the head 8B of the second portion 82 of the first rod 8A of the shoulder bolt 8, and the third bottom surface 67 of the column 6 (refer to FIGS. 12 and 13) abut on the flat washer 7C. By the third portion 83 of the first rod 8A of the shoulder bolt 8 being fixed to the shaft 14A, the flat washer 7C is supported by the shaft 14A via the column 6. The flat washer 7C is provided to suppress abrasion of the column 6.

<Cover 9G>

As depicted in FIG. 11, the cover 9G is provided to the tip 59 of the rotating body 5. The tip 59 of the rotating body 5 is a tip positioned oppositely to the plate 31 in the front-rear direction. The cover 9G has a circular plate-like shape. The cover 9G is orthogonal to the front-rear direction. The rotational center 5X passes through a center of the cover 9G. Through-holes 96A, 96B, 97A, 97B are formed in the cover 9G. The through-holes 96A, 96B face each other sandwiching the rotational center 5X. The through-holes 97A, 97B face each other sandwiching the rotational center 5X. The cover 9G is fixed to the rotating body 5 by raised countersunk head screws 98 being screwed into the through-holes 96A, 96B and holes 59A, 59B provided in the tip 59 of the rotating body 5. As depicted in FIGS. 12 and 13, in a state where the cover 9G has been fixed to the rotating body 5, the cover 9G covers the head 8B of the shoulder bolt 8. The projecting sections 95 of the second rods 9C, 9D are inserted from the front side in the through-holes 97A, 97B of the cover 9G, and project to the rear side of the cover 9G.

<Summary of Operation of Cassette 1B>

A description of the cassette 1B when the second rods 9C, 9D are positioned in the first position, will be given using FIG. 12. The cassette 1B is assumed to be not installed in the printing apparatus 1A at this time. As depicted in FIGS. 12 and 13, the spring washer 7B is sandwiched in the front-rear direction by the first bottom surface 61 of the column 6 and the head 8B of the shoulder bolt 8. Due to the spring washer 7B being sandwiched by the first bottom surface 61 and the head 8B of the shoulder bolt 8, the spring washer 7B exerts a biasing force pressing the column 6 onto the shaft 14A. As a result of this biasing force due to the spring washer 7B, a frictional force, that is, a braking force occurs between the third bottom surface 67 of the column 6 and the flat washer 7C and between the flat washer 7C and the end surface of the tip 143 of the shaft 14A. Therefore, due to the spring washer 7B, the column 6 is supported in a rotatable manner with respect to the shaft 14A, while receiving an appropriate frictional force. That is, although the column 6 is supported in a rotatable manner by the shaft 14A, the column 6 does not rotate too much with respect to the shaft 14A.

In the first position, the first projections 91A, 91B of the second rods 9C, 9D are inserted in the grooves 60 of the column 6. The first projections 91A, 91B abut on the first wall 65A and the second wall 65B (refer to FIG. 17) forming the grooves 60. Therefore, the rotating body 5 is enabled to rotate along with the column 6. Due to the column 6 receiving the frictional force, that is, the braking force, the rotating body 5 also receives an appropriate force so as to prevent it from rotating too much with respect to the shaft 14A, and rotation of the rotating body 5 is suppressed. This force received by the rotating body 5 applies an appropriate back-tension to the ink ribbon 9 when the user is guiding the ink ribbon 9 to the rotating body 5. Therefore, guide work of the ink ribbon 9 by the user is made easy. Moreover, the spring washer 7B causes a biasing force in a direction of approaching the column 6, to act on the flat washer 7A. Therefore, a frictional force occurs also between the flat washer 7A and the column 6. The flat washer 7A suppresses abrasion of the column 6. In addition, a biasing force in a direction of approaching the flat washer 7C, acts on the column 6. Therefore, a frictional force occurs also between the flat washer 7C and the column 6. The flat washer 7C suppresses abrasion of the column 6.

Note that the second rods 9C, 9D receive from the springs 9E, 9F a biasing force in the direction of separating from the plate 31. Therefore, the second rods 9C, 9D receive a biasing force in a direction that the first projections 91A, 91B enter the grooves 60 of the column 6. Hence, when an external force is not acting on the second rods 9C, 9D, the rotating body 5 is held in the first position.

When the cassette 1B has been installed in the printing apparatus 1A, the projecting sections 95 of the second rods 9C, 9D fit in the holes 220 of the installing sections 22A, 22F of the printing apparatus 1A. The second rods 9C, 9D are pressed in the direction of approaching the plate 31 and move to the second position, opposing the biasing force of the springs 9E, 9F.

A description of the cassette 1B when the second rods 9C, 9D are positioned in the second position, will be given with reference to FIG. 13. In a state where the second rods 9C, 9D have been disposed in the second position, the grooves 60 of the column 6 are disposed in positions separated to the rear side from the first projections 91A, 91B provided in the second rods 9C, 9D. The first projections 91A, 91B are not disposed on the insides of the grooves 60 of the column 6, so the rotating body 5 is enabled to rotate independently from the column 6. Therefore, the rotating body 5 can be easily rotated with respect to the shaft 14A attached to the column 6.

<Method of Installing Ink Ribbon 9 in Cassette 1B>

A method of installing when the ink ribbon 9 is installed in the cassette 1B will be described. The ink ribbon 9 (refer to FIG. 4) in a state where both ends thereof have been respectively connected to the spools 9A, 9B (refer to FIG. 4) and the ribbon roll 90 (refer to FIG. 4) is held in the spool 9A, is installed in the cassette 1B (refer to FIG. 4) as follows. Note that as depicted in FIG. 12, the second rods 9C, 9D move in the direction of separating from the plate 31 and are held in the first position, in response to the biasing force received from the springs 9E, 9F.

First, the user installs the spool 9A in the shaft 132A, and installs the spool 9B in the shaft 132F. The springs 5C, 5D of the rotating body 5 enter through-holes of the spools 9A, 9B while respectively deforming the two curved sections 55C, 55D to a main body 5A side. The two curved sections 55C, 55D each make firm and close contact from the inside with inner walls of the spools 9A, 9B due to stress on the two curved sections 55C, 55D. As a result, rotation of the spools 9A, 9B with respect to the rotating body 5 is restricted. Front ends of each of the spools 9A, 9B and the ribbon roll 90 abut, from the rear side, on the plate portion 57 of the pedestal 5B of the rotating body 5. As a result, the spool 9A and the ribbon roll 90 are positioned with respect to the shaft 132A, and the spool 9B is positioned with respect to the shaft 132F. Note that since the second rods 9C, 9D are held in the first position, rotation of the rotating body 5 with respect to the shaft 14A is suppressed.

Next, the user guides the ink ribbon 9 onto the shafts 32B-32E. When the ink ribbon 9 is pulled out from the shaft 132A, then due to a force by which the ink ribbon 9 is pulled out, the rotating body 5 rotates in a state of the second rods 9C, 9D being disposed in the first position (refer to FIG. 12). Because, as mentioned above, rotation of the rotating body 5 is suppressed, and, moreover, the ink ribbon 9 is applied with a back-tension, the user can easily guide the ink ribbon 9. The above results in a state where the ink ribbon 9 is stretched over the shafts 32B-32E, that is, a state of there being no slack in the ink ribbon 9.

<Printing Operation Due to Printing Apparatus 1A>

The user grips the handle 30 (refer to FIG. 1) of the cassette 1B in which the ink ribbon 9 is supported, and moves the cassette 1B that has been disposed on the front side of the printing apparatus 1A, to the rear side, in a sliding manner. As a result, the cassette 1B is inserted inside the casing 12 via the opening on the front side of the casing 12. The shafts 32 of the cassette 1B are engaged with the installing sections 22 of the printing apparatus 1A. The projecting sections 95 of the second rods 9C, 9D of the shafts 132A, 132F fit in the holes 220 of the installing sections 22A, 22F of the printing apparatus 1A. The second rods 9C, 9D receive from the installing sections 22A, 22F a force in a direction of approaching the plate 31. The second rods 9C, 9D move from the first position (refer to FIG. 12) to the second position (refer to FIG. 13). Suppression of rotation with respect to the shaft 14A, for the respective rotating bodies 5 of the shafts 132A, 132F, is released. The rotating bodies 5 are enabled to rotate in response to rotation of the motors M of the printing apparatus 1A. A portion stretched across between the shafts 32C, 32D of the ink ribbon 9 of the cassette 1B is contacted from the upper side by the thermal head 26 of the printing apparatus 1A. As depicted in FIG. 1, the plate 31 of the cassette 1B covers the opening on the front side of the casing 12 of the printing apparatus 1A.

The printing apparatus 1A rotates the rotating bodies 5 of the cassette 1B by drive of the motors M. The ink ribbon 9 is fed out from the ribbon roll 90 of the cassette 1B, and moves between the shafts 32B-32E. The thermal head 26 heats the portion stretched across between the shafts 32C, 32D, of the ink ribbon that has been fed out from the ribbon roll 90. Ink of the ink ribbon 9 is transferred to the printing medium that has been disposed on the lower side of the printing apparatus 1A, by heating. The ink ribbon 9 that has undergone heating is wound onto the spool 9B.

[Main Actions and Advantages of Second Embodiment]

The cassette 1B includes the plate 31, the shaft 14A, the rotating body 5, the column 6, the first rod 8A and head 8B of the shoulder bolt 8, the second rods 9C, 9D, the first projections 91A, 91B, and the spring washer 7B. The shaft 14A is provided to the plate 31. The shaft 14A extends in a direction intersecting the plate 31. The hole 143A is formed in the end surface of the tip 143 of the shaft 14A. The rotating body 5 is provided at least partly around the shaft 14A. The rotating body 5 is capable of rotating around the shaft 14A. The column 6 is provided to the tip 143 of the shaft 14A. The circular column 6A of the column 6 includes the first bottom surface 61, the second bottom surface 62, the side surface 63, the through-hole 164A, and the grooves 60. The distance between the first bottom surface 61 and the plate 31 is the first distance L11. The distance between the second bottom surface 62 and the plate 31 is the second distance L12 which is smaller than the first distance L11. The through-hole 164A penetrates between the first bottom surface 61 and the second bottom surface 62. The grooves 60 are provided in the side surface 63. The grooves 60 are formed by the first wall 65A and the second wall 65B that extend from the second bottom surface 62 toward the first bottom surface 61 and face each other. The first rod 8A of the shoulder bolt 8 is inserted in the through-hole 164 of the column 6 and the hole 143A of the shaft 14A, and thereby attaches the column 6 to the shaft 14A. The head 8B is provided on an opposite side to the shaft 14A of the first rod 8A. The second rods 9C, 9D are provided to the rotating body 5. The second rods 9C, 9D are capable of moving in a direction parallel to the rotational center 5X of the rotating body 5. The first projections 91A, 91B are provided in the second rods 9C, 9D. The first projections 91A, 91B project toward the rotational center 5X. The first projections 91A, 91B are capable of entering inside the grooves 60 of the column 6. The first projections 91A, 91B are capable of abutting on the first wall 65A and the second wall 65B of the grooves 60. The spring washer 7B is provided between the first bottom surface 61 of the column 6, and the head 8B of the shoulder bolt 8.

In the cassette 1B, the column 6 is pressed against the end surface of the tip 143 of the shaft 14A, due to the biasing force of the spring washer 7B. The frictional force between the shaft 14A and the column 6 makes it difficult for the column 6 to rotate with respect to the shaft 14A. Moreover, in a state where the first projections 91A, 91B provided in the second rods 9C, 9D have been inserted in the grooves 60 of the column 6, rotation of the rotating body 5 with respect to the column 6 is restricted. In other words, in a state where the first projections 91A, 91B provided in the second rods 9C, 9D have been inserted in the grooves 60 of the column 6, it becomes difficult for the rotating body 5 to rotate with respect to the shaft 14A. Therefore, the cassette 1B can suppress rotation of the rotating body 5 in the case where the ribbon roll 90 having the ink ribbon 9 wound therein is installed in the rotating body 5. Hence, the user can easily perform guide work of the ink ribbon 9 during installation of the ink ribbon 9 in the cassette 1B.

Moreover, an example is given of a case where, unlike in the second embodiment, rotation of the rotating body 5 is restricted in response to the rotating body 5 moving in a direction parallel to the rotational center 5X, and restriction of rotation of the rotating body 5 is released in response to the rotating body 5 returning to an initial position. In this case, a positional relationship in the front-rear direction of the shafts 132A, 132F and the shafts 32B-32E on which the ink ribbon 9 is guided, changes with movement of the rotating body 5. Therefore, there is a possibility that when, for example, the ink ribbon 9 has been guided between the shafts 32B-32E in a state where rotation of the rotating bodies 5 of the shafts 132A, 132F has been restricted, and then restriction of rotation of the rotating bodies 5 has been released to start printing, a crease occurs in the ink ribbon 9 that has been guided between the shafts 32B-32E. In contrast, in the second embodiment, in the cassette 1B, rotation of the rotating body 5 is restricted in response to the second rods 9C, 9D moving in a direction parallel to the rotational center 5X. In other words, the positional relationship in the front-rear direction of the shafts 132A, 132F and the shafts 32B-32E does not change for a state where rotation of the rotating bodies 5 has been restricted and a state where it is not restricted. Therefore, a reduction can be made in the possibility that when, for example, the ink ribbon 9 has been stretched between the shafts 32B-32E in a state where rotation of the rotating bodies 5 of the shafts 132A, 132F has been restricted, and then restriction of rotation of the rotating bodies 5 has been released to start printing, a crease is formed in the ink ribbon 9 that has been guided between the shafts 32B-32E.

The space between the first wall 65A and the second wall 65B of the column 6 gets larger as the second bottom surface 62 is approached. In this case, in the process of the rotating body 5 moving from the second position toward the first position, the first projections 91A, 91B are guided by the first wall 65A and the second wall 65B and are easily inserted in the grooves 60. Therefore, in the cassette 1B, the first projections 91A, 91B can be easily switched from a state of not being inserted in the grooves 60 to a state of being inserted in the grooves 60.

The space between the first wall 65A and the second wall 65B of the column 6 gets continuously larger as the second bottom surface 62 is approached. In this case, in the cassette 1B, the first projections 91A, 91B can be smoothly inserted inside the grooves 60.

The first wall 65A and the second wall 65B are joined at the joining section 65C positioned between the first bottom surface 61 and the second bottom surface 62 in the direction parallel to the rotational center 5X. When the first projections 91A, 91B have entered the grooves 60 and each of the first projections 91A, 91B have abutted on the first wall 65A and the second wall 65B, the first projections 91A, 91B are positioned between the joining section 65C and the second bottom surface 62. A gap is formed between the first projections 91A, 91B and the joining section 65C. Therefore, when the first projections 91A, 91B have been inserted in the grooves 60, the first projections 91A, 91B abut on the first wall 65A and the second wall 65B at the certain positions 653A, 653B of the grooves 60. In this case, in the cassette 1B, the first projections 91A, 91B can be abutted on both the first wall 65A and the second wall 65B of the column 6, even when variation has occurred in spacing of the grooves 60 due to individual differences.

The spring washer 7B functions as an elastic body. Therefore, in the cassette 1B, an impact received from the column 6 by the second portion 82 of the first rod 8A and an impact received by the grooves 60 from the first projections 91A, 91B when the first projections 91A, 91B have been inserted in the grooves 60, are absorbed by the spring washer 7B.

The cassette 1B further includes the flat washer 7A between the first bottom surface 61 of the column 6 and the head 8B of the shoulder bolt 8. In this case, the flat washer 7A can reduce abrasion of the column 6 due to the column 6 rotating with respect to the shaft 14A and the first rod 8A.

The shoulder bolt 8 is configured by the first rod 8A and the head 8B. The first rod 8A includes the first portion 81, the second portion 82, and the third portion 83. A screw thread is formed in the side surface of the first portion 81. The first portion 81 is inserted in the hole 143A of the shaft 14A. The second portion 82 is disposed between the head 8B and the first portion 81. The diameter R22 of the second portion 82 is larger than the diameter R21 of the first portion 81 and smaller than the diameter R41 of the shaft 14A. The end surface 86 faces the end surface of the tip 143 of the shaft 14A sandwiching the flat washer 7C. The third portion 83 is disposed between the first portion 81 and the second portion 82. The third portion 83 is inserted in the hole 143A of the shaft 14A. The diameter R23 of the third portion 83 is smaller than the diameter R21 of the first portion 81. In this case, a region held by the column 6 is secured between the head 8B and the shaft 14A in a state where the first portion 81 of the first rod 8A has been screwed into the hole 143A of the shaft 14A. Therefore, in the cassette 1B, the column 6 can be easily assembled in the shaft 14A by the shoulder bolt 8.

The main body 5A of the rotating body 5 has a cylindrical shape. The shaft 14A is inserted in the cavity 51A of the main body 5A of the rotating body 5. In this case, the rotating body 5 can support the entire inner side of the installed spools 9A, 9B. Therefore, the rotating body 5 can stably hold the ribbon roll 90 that has the ribbon wound therein.

The cassette 1B includes the springs 9E, 9F that bias the second rods 9C, 9D in the direction of separating from the plate 31. Due to a biasing force of the springs 9E, 9F, the springs 9E, 9F can cause the second rods 9C, 9D to move in the direction of separation from the plate 31 and can cause the first projections 91A, 91B to enter the grooves 60.

The previously described projecting sections 95 of the second rods 9C, 9D project from the end section opposite to the plate 31 of the rotating body 5 (the tip 59 of the rotating body 5). In the cassette 1B, by the projecting sections 95 of the second rods 9C, 9D fitting into the holes 220 of the installing sections 22A, 22F of the printing apparatus 1A and the second rods 9C, 9D moving to the plate 31 side, the rotating body 5 is released from the state of having its rotation with respect to the shaft 14A restricted. By the installing sections 22A, 22F of the printing apparatus 1 being rotated by the motors M, the ribbon roll 90 that has been installed in the rotating body 5 is rotated, thereby enabling the ink ribbon 9 to be conveyed.

The diameter of the projecting section 95 of the second rods 9C, 9D gets smaller the more the tip of each of the second rods 9C, 9D is neared. Therefore, in the cassette 1B, the projecting sections 95 of the second rods 9C, 9D can be easily fitted into the holes 220 of the installing sections 22A, 22B of the printing apparatus 1A.

The resin 50 is provided between the second rods 9C, 9D and the rotating body 5. The resin 50 can suppress occurrence of sound due to contact between the second rods 9C, 9D and the rotating body 5.

The column 6 includes the cylinder 6B that extends from the second bottom surface 62 of the circular column 6A toward the tip 143 of the shaft 14A. The cylinder 6B includes the through-hole 164B. The through-hole 164B is integrated with the through-hole 164A of the circular column 6A to form the through-hole 164 in the column 6. The first rod 8A of the shoulder bolt 8 passes through the through-hole 164. Therefore, in the cassette 1B, a contact area between the column 6 and the first rod 8A can be made larger, hence a position of the column 6 with respect to the shaft 14A can be stabilized more compared to when there is not a cylinder 6B.

The flat washer 7C is provided between the third bottom surface 67 of the cylinder 6B of the column 6 and the shaft 14A. In this case, the flat washer 7C can reduce abrasion of the column 6 due to the column 6 rotating with respect to the shaft 14A and the first rod 8A.

The cover 9G is provided to the end section opposite to the plate 31 of the rotating body 5 (the tip 59 of the rotating body 5). The cover 9G covers the head 8B of the shoulder bolt 8. Therefore, in the cassette 1B, exposure of the head 8B can be suppressed by the cover 9G.

The rotating body 5 includes the cavity 51A that extends toward the plate 31 from the end section opposite to the plate 31 of the rotating body 5 (the tip 59 of the rotating body 5). The cavity 51A is formed from by: the first surface 511 that extends toward the plate 31 from the tip 59 of the rotating body 5, to a first boundary position 51P; the second surface 512 that extends toward the rotational center 5X from the first boundary position 51P, to a second boundary position 51Q; and a third surface 513 that extends toward the plate 31 from the second boundary position 51Q. The shaft 14A and the column 6 are provided in the cavity 51A. The cylinder 6B includes the third bottom surface 67 whose distance between itself and the plate 31 is the third distance L13 which is smaller than the second distance L12. Part of the third bottom surface 67 of the cylinder 6B, and the second surface 512 of the cavity 51A are capable of making contact. In this case, positioning of the rotating body 5 in the direction parallel to the rotational center 5X can be achieved by part of the cylinder 6B of the column 6, and the second surface 512 of the cavity 51A. Moreover, by the second surface 512 of the rotating body 5 contacting part of the cylinder 6B, it is possible to suppress that the rotating body 5 detaches from the shaft 14A.

The shaft 14A includes the fourth projection 141 that extends in the direction intersecting the rotational center 5X. The fourth projection 141 includes the fourth surface 141A and the fifth surface 141B that are orthogonal to the rotational center 5X. The distance L41 between the fourth surface 141A and the plate 31 is larger than the distance L42 between the fifth surface 141B and the plate 31. Part of the sixth surface 142 facing the plate 31 of the rotating body 5, and the fourth surface 141A of the shaft 14A are capable of making contact. In this case, positioning of the rotating body 5 in the direction parallel to the rotational center 5X can be achieved by the fourth surface 141A of the shaft 14A and the sixth surface 142 of the rotating body 5.

The rotating body 5 includes the bearing 4C that bears the shaft 14A. The sixth surface 142 is formed by part of the bearing 4C. In this case, the bearing 4C enables the rotating body 5 to be smoothly rotated with respect to the shaft 14A. Moreover, in the cassette 1B, positioning of the rotating body 5 can be achieved by the bearing 4C.

The second rods 9C, 9D of the cassette 1B are disposed in the first position in a state before the cassette 1B is installed in the printing apparatus 1A. In this case, rotation of the rotating body 5 is restricted, so the user can easily guide the ink ribbon 9 to the cassette 1B. Hence, the cassette 1B is installed in the printing apparatus 1A in a state where the ink ribbon 9 has been firmly guided onto the shafts 32B-32E, that is, in a state where the ink ribbon 9 has been firmly tensioned between the shafts 32B-32E. It is therefore possible to suppress a risk that the ink ribbon 9 interferes with a member of the printing apparatus 1A, for example, the thermal head 26, or the like, whereby installation of the cassette 1B is hindered.

The printing apparatus 1A includes the installing sections 22, the motors M, and the thermal head 26. The cassette 1B is installed in the installing sections 22. The projecting sections 95 of the second rods 9C, 9D of the cassette 1B fit into the holes 220 of the installing sections 22A, 22F of the printing apparatus 1A, whereby the second rods 9C, 9D move to the second position. The state where rotation of the rotating bodies 5 has been restricted, is released. In the printing apparatus 1A, the installing sections 22A, 22F are rotated by the motors M, whereby the ribbon roll 90 installed in the rotating bodies 5 is rotated, and the ink ribbon 9 is conveyed. The thermal head 26 heats the ink ribbon 9 that has been fed out from the cassette 1B in response to the rotating bodies 5 being rotated by the motors M. The printing apparatus 1A enables slack of the ink ribbon 9 to be suppressed, so a possibility of, for example, the ink ribbon 9 becoming charged, and the ink ribbon 9 being attracted to the printing medium by static electricity during the printing operation, can be reduced.

### Third Embodiment

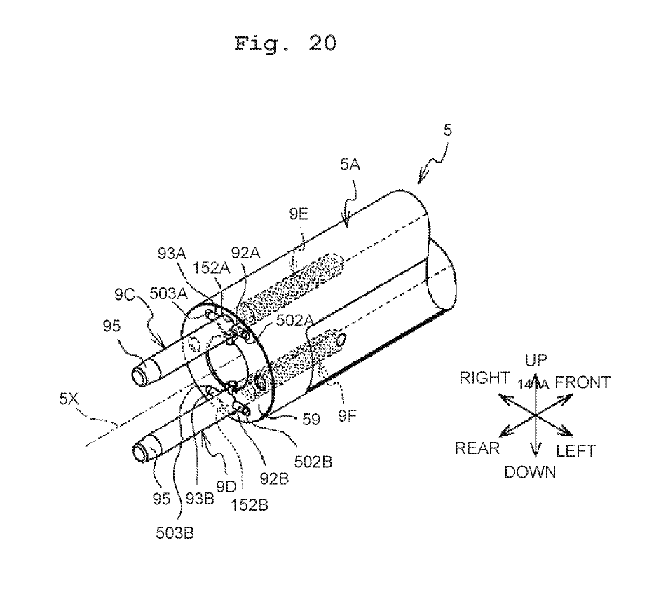

A third embodiment of the present teaching will be described with reference to FIGS. 19 and 20. In the third embodiment, configurations of the second rods 9C, 9D and the rotating body 5 are different from in the second embodiment. As depicted in FIG. 19, the second rod 9C is provided with a second projection 92A and a third projection 93A. The second projection 92A extends to the left orthogonally to the rotational center 5X of the rotating body 5. The third projection 93A extends to the right orthogonally to the rotational center 5X. Respective positions in the front-rear direction of the first projection 91A, the second projection 92A, and the third projection 93A are identical. Respective extending directions of the first projection 91A and the second projection 92A are orthogonal to each other. Respective extending directions of the first projection 91A and the third projection 93A are orthogonal to each other. The second projection 92A and the third projection 93A extend in opposite directions to each other. Similarly, the second rod 9D is provided with a second projection 92B and a third projection 93B. The second projection 92B and the third projection 93B respectively correspond to the second projection 92A and the third projection 93A provided in the second rod 9C.

Grooves 502A, 503A, 502B, 503B extending in the left-right direction are formed in the main body 5A of the rotating body 5. The groove 502A extends in a leftward direction from the hole 152A. The groove 503A extends in a rightward direction from the hole 152A. The grooves 502A, 503A are arranged in a straight line in the left-right direction. The groove 502B extends in a leftward direction from the hole 152B. The groove 503B extends in a rightward direction from the hole 152B. The grooves 502B, 503B are arranged in a straight line in the left-right direction. Widths of the grooves 502A, 503A, 502B, 503B are smaller than the diameters of the holes 152A, 152B.

As depicted in FIG. 20, when the second rod 9C has been inserted from the rear side in the hole 152A, the second projection 92A fits in the groove 502A, and the third projection 93A fits in the groove 503A. When the second rod 9D has been inserted from the rear side in the hole 152B, the second projection 92B fits in the groove 502B, and the third projection 93B fits in the groove 503B. Rotation centered on respective axes of the second rods 9C, 9D is restricted by the second projections 92A, 92B contacting inner walls of the grooves 502A, 502B, and the third projections 93A, 93B contacting inner walls of the grooves 503A, 503B.

In the cassette 1B in the above third embodiment, the second rods 9C, 9D are provided with the second projections 92A, 92B. The second projections 92A, 92B extend from the second rods 9C, 9D in a direction (the leftward direction) orthogonal to the rotational center 5X. In this case, since rotation of the second rods 9C, 9D is restricted by the second projections 92A, 92B, it can be restricted that the first projections 91A, 91B move in response to rotation of the second rods 9C, 9D. Therefore, since at an intersecting portion with the grooves 60 of the column 6, it can be restricted that the first projections 91A, 91B move with respect to the column 6, a possibility of the rotating body 5 rattling against the shaft 14A can be reduced.

Respective extending directions of the first projections 91A, 91B and the second projections 92A, 92B are orthogonal to each other. In this case, it can be effectively restricted by the second projections 92A, 92B that the first projections 91A, 91B move in response to rotation of the second rods 9C, 9D. Therefore, the cassette 1B can further reduce the possibility of the rotating body 5 rattling against the shaft 14A.

The second rods 9C, 9D are further provided with the third projections 93A, 93B that are orthogonal to the rotational center 5X and extend in the opposite direction to the second projections 92A, 92B (the rightward direction). In this case, rotation of the second rods 9C, 9D can be certainly restricted by the second projections 92A, 92B and the third projections 93A, 93B. Note that although in the third embodiment, respective positions in the front-rear direction of the first projection 91A, the second projection 92A, and the third projection 93A were identical, the respective positions in the front-rear direction may be different.

### Modified Examples

The present teaching is not limited to the above-described second embodiment and third embodiment, and may undergo a variety of changes. The direction that the shaft 14A extends with respect to the plate 31 is not limited to a direction orthogonal to the plate 31. The shaft 14A may extend in a slanted direction with respect to the direction orthogonal to the plate 31. The shaft 14A need not be fixed with respect to the plate 31. In this case, for example, the shaft 14A may be rotatable at a certain angle with respect to the plate 31. Moreover, for example, the shaft 14A may be movable in at least any one direction of the up-down direction and the left-right direction, with respect to the plate 31. The main body 5A of the rotating body 5 may have a shape other than a cylindrical shape. For example, a plurality of through-holes may be provided in a side surface of the main body 5A of the rotating body 5. In this case, the main body 5A may be provided so as to only partly cover around the shaft 14A. Furthermore, when the main body 5A has a shape other than a cylindrical shape, the cavity 51A need not be provided. In this case, the shaft 14A need not be inserted in the cavity 51A. The height of the column 6 may be longer than the diameter of the column 6, or the height and diameter of the column 6 may be identical.

The shoulder bolt 8 may include only the first portion 81 and the second portion 82, and need not include the third portion 83. Another member having a rod and a head may be employed instead of the shoulder bolt 8. A member not having a screw thread formed therein, for example, an interference fit, may be employed as the rod.

The first wall 65A and the second wall 65B forming the grooves 60 may each be curved convexly toward the inside of the grooves 60. Even in this case, the space between the first wall 65A and the second wall 65B may get continuously larger as the second bottom surface 62 is approached.

Steps may be provided in each of the first wall 65A and the second wall 65B. In this case, for example, there may be provided in each of the first wall 65A and the second wall 65B at least first steps parallel to the front-rear direction passing through the places 651A, 651B, second steps parallel to the front-rear direction passing through the certain positions 653A, 653B, and third steps parallel to the front-rear direction passing through the ends 652A, 652B. The space between the first wall 65A and the second wall 65B may get larger in a discontinuous manner as the second bottom surface 62 is approached. Furthermore, the first wall 65A and the second wall 65B forming the grooves 60 may each extend in parallel with the front-rear direction, from the second bottom surface 62 toward the first bottom surface 61. The space between the first wall 65A and the second wall 65B may be uniform spanning from the places 651A, 651B on the first bottom surface 61 side to the ends 652A, 652B on the second bottom surface 62 side.

The width L22 between the one end 56A and the other end 56B of the first projections 91A, 91B may be smaller than the space L21 between the places 651A, 651B on the first bottom surface 61 side. In this case, the first projections 91A, 91B may abut on the joining section 65C in a state of having been disposed in the groove 60B. A gap need not be formed between the first projections 91A, 91B and the joining section 65C. The radius R12 of the arc 651 may be larger than a radius R11 of the first projections 91A, 91B.

The flat washers 7A, 7C are not limited to being made of a resin, and may be formed by another material. The flat washers 7A, 7C need not be provided. When the flat washer 7C is not provided, the end surface 86 on the opposite side to the head 8B, of the second portion 82 of the first rod 8A of the shoulder bolt 8 may abut on part of the end surface of the tip 143 of the shaft 14A. The spring washer 7B is not limited to being made of a metal, and may be formed by another material. The spring washer may be provided between the flat washer 7C and the shaft 14A. Another elastic body (for example, a plate spring, a coil spring, rubber, or the like) may be employed instead of the spring washer.

The projecting section 95 of the second rods 9C, 9D need not be provided with a taper. The diameter of the projecting section 95 may be identical spanning the front-rear direction of the second rods 9C, 9D. The second rods 9C, 9D need not project from the tip 59 of the rotating body 5. In this case, for example, projecting sections projecting in a frontward direction may be provided to the installing sections 22A, 22F of the printing apparatus 1A. The second rods 9C, 9D may be moved from the first position to the second position by the projecting sections of the installing sections 22A, 22F pressing the second rods 9C, 9D to the front side when the cassette 1B has been installed in the printing apparatus 1A. Grease may be provided between the second rod 9C and wall surface of the hole 152A and between the second rod 9D and wall surface of the hole 152B, instead of the resin 50. The resin 50 need not be provided. The tip 59 of the rotating body 5 need not be provided with the cover 9G.

The column 6 may have only the circular column 6A, and need not have the cylinder 6B. The cylinder 6B need not be provided with the projecting section 6C. In this case, the second bottom surface 62 of the circular column 6A may abut from the rear on the flat washer 7C, and may face the end surface of the tip 143 of the shaft 14A. Furthermore, part of the second bottom surface 62 of the circular column 6A may abut on the end surface of the tip 143 of the shaft 14A when the flat washer 7C is not included.

The diameter of the through-hole 51 of the rotating body 5 may be identical spanning from its front end to its rear end. A step need not be formed in the through-hole 51. In this case, a member enabling detachment of the rotating body 5 from the shaft 14A to be restricted, may be newly provided.

The shaft 14A need not be provided with the fourth projection 141. In this case, the sixth surface 142 facing the plate 31, of the rotating body 5 may be capable of contacting the plate 31. In this case, movement in the frontward direction of the rotating body 5 with respect to the shaft 14A is restricted by the sixth surface 142 of the rotating body 5 contacting the plate 31 from the rear. Therefore, in the cassette 1B, positioning of the rotating body 5 in the direction parallel to the rotational center 5X can be achieved by the sixth surface 142 of the rotating body 5 and the plate 31.

The rotating body 5 need not be provided with the bearing 4C. In this case, the hole 53 for fitting the bearing 4C need not be provided in the rotating body 5. Moreover, part of a front end surface of the main body 5A of the rotating body 5 may be capable of contacting the fourth surface 141A of the fourth projection 141 of the shaft 14A.

The method of installing the ink ribbon 9 in the cassette 1B is not limited to the method described in the above-described second embodiment. For example, the ink ribbon 9 may be installed in the cassette 1B as follows. First, the user installs in the shaft 132A the spool 9A in which the ribbon roll 90 is held. Note that the rotating body 5 of the shaft 132A is held in the first position, and rotation of the rotating body 5 with respect to the shaft 14A is suppressed. Next, the user pulls out the ink ribbon 9 from the ribbon roll 90 by holding the spool 9B to separate the spool 9B from the spool 9A. At the same time, the user guides the pulled out ink ribbon 9 between the shafts 32B-32E by moving the spool 9B so as to surround the shafts 32B-32E from the outside. Note that since rotation of the rotating body 5 is suppressed, the ink ribbon 9 is stretched across between the shafts 32B-32E in a state of having been applied with a back-tension. As a result, the user can easily guide the ink ribbon 9 between the shafts 32B-32E without causing slack in the ink ribbon 9. Finally, the user installs the spool 9B in the shaft 132F. Note that the rotating body 5 of the shaft 132F is held in the first position, and rotation of the rotating body 5 with respect to the shaft 14A is suppressed. Therefore, a state of the ink ribbon 9 being stretched across with no slack is maintained even after the spool 9B has been installed in the shaft 132F.

What is claimed is:

1. An ink ribbon supporting cassette comprising:
a plate;
a shaft provided for the plate, the shaft extending in a direction intersecting the plate, the shaft having a hole formed in a tip of the shaft;
a rotating body provided for at least a part of the shaft to be rotatable around the shaft;
a spring disposed between the plate and the rotating body, the spring biasing the rotating body in a direction separating from the plate;
a column provided for the tip of the shaft, the column including: a first bottom surface; a second bottom surface; and a side surface, a first distance between the first bottom surface and the plate being shorter than a second distance between the second bottom surface and the plate, the column including: a through-hole which penetrates between the first bottom surface and the second bottom surface; and a groove provided for the side surface and formed by a first wall and a second wall which extend from the second bottom surface toward the first bottom surface and face each other;
a rod inserted in the through-hole of the column and the hole of the shaft to attach the column to the shaft;
a head provided on an end, of the rod, opposite to the shaft;
a projection provided for the rotating body, the projection projecting toward a rotational center of the rotating body, the projection being configured to enter the groove and to make contact with at least one of the first wall and the second wall of the column; and
an elastic body disposed between the first bottom surface of the column and the head.

2. The ink ribbon supporting cassette according to claim 1, wherein a spacing distance between the first wall and the second wall of the column is increased toward the second bottom surface.

3. The ink ribbon supporting cassette according to claim 2, wherein the spacing distance is continuously increased toward the second bottom surface.

4. The ink ribbon supporting cassette according to claim 2, wherein the first wall and the second wall are joined at an end portion positioned between the first bottom surface and the second bottom surface in a direction parallel to the rotational center, and
in a state that the projection has entered the groove and has been in contact with the first wall and the second wall, the projection is positioned between the end portion and the second bottom surface, and a gap is formed between the projection and the end portion.

5. The ink ribbon supporting cassette according to claim 1, wherein the elastic body is a spring washer.

6. The ink ribbon supporting cassette according to claim 5, further comprising a washer between the second bottom surface of the column and the shaft or between the first bottom surface of the column and the head.

7. The ink ribbon supporting cassette according to claim 5, wherein the rod and the head compose a shoulder bolt, and
the rod includes:
a first portion in which a screw is formed, the first portion being inserted in the hole of the shaft;
a second portion disposed between the head and the first portion, the second portion having a diameter which is larger than a diameter of the first portion and smaller than a diameter of the shaft, the second portion having an end surface on a side opposite to the head, the end surface of the second portion being in contact with the tip of the shaft; and
a third portion disposed between the first portion and the second portion, the third portion being inserted in the hole of the shaft and having a diameter smaller than the diameter of the first portion.

8. The ink ribbon supporting cassette according to claim 1, wherein the rotating body has a cylindrical shape, and
the shaft is inserted in a cavity formed in a center of the rotating body.

9. A printing apparatus comprising:
an installing section in which the ink ribbon supporting cassette as defined in claim 1 is installed;
a motor configured to rotate the rotating body of the ink ribbon supporting cassette that has been installed in the installing section; and
a thermal head configured to heat an ink ribbon which has been fed out from the ink ribbon supporting cassette in response to rotation of the rotating body by the motor.

10. An ink ribbon supporting cassette comprising:
a plate;
a shaft provided for the plate, the shaft extending in a direction intersecting the plate, the shaft having a hole formed in a tip of the shaft;
a rotating body provided for at least a part of the shaft to be rotatable around the shaft;
a column provided for the tip of the shaft, the column including: a first bottom surface; a second bottom surface; and a side surface, a first distance between the first bottom surface and the plate being shorter than a second distance between the second bottom surface and the plate, the column including: a through-hole which penetrates between the first bottom surface and the second bottom surface; and a groove provided for the side surface and formed by a first wall and a second wall which extend from the second bottom surface toward the first bottom surface and face each other;
a first rod inserted in the through-hole of the column and the hole of the shaft to attach the column to the shaft;
a head provided on a side opposite to the shaft with respect to the first rod;
a second rod provided for the rotating body, the second rod extending in a direction parallel to a rotational center of the rotating body, the second rod being movable with respect to the column in the direction parallel to the rotational center;
a first projection provided for the second rod, the first projection projecting toward the rotational center, the first projection being configured to enter the groove and to make contact with the first wall and the second wall of the column; and
an elastic body disposed between the first bottom surface of the column and the head.

11. The ink ribbon supporting cassette according to claim 10, wherein a spacing distance between the first wall and the second wall of the column is increased toward the second bottom surface.

12. The ink ribbon supporting cassette according to claim 11, wherein the spacing distance is continuously increased toward the second bottom surface.

13. The ink ribbon supporting cassette according to claim 11, wherein the first wall and the second wall are joined at a joining portion positioned between the first bottom surface and the second bottom surface in the direction parallel to the rotational center, and
in a state that the first projection has entered the groove and has been in contact with the first wall and the second wall, the first projection is positioned between the joining portion and the second bottom surface, and a gap is formed between the first projection and the joining portion.

14. The ink ribbon supporting cassette according to claim 10, wherein the elastic body is a spring washer.

15. The ink ribbon supporting cassette according to claim 14, further comprising a first washer between the first bottom surface of the column and the head.

16. The ink ribbon supporting cassette according to claim 14, wherein the first rod and the head compose a shoulder bolt, and
the first rod includes:
a first portion in which a screw is formed, the first portion being inserted in the hole of the shaft;
a second portion disposed between the head and the first portion, the second portion having a diameter which is larger than a diameter of the first portion and smaller than a diameter of the shaft; and
a third portion disposed between the first portion and the second portion, the third portion being inserted in the hole of the shaft and having a diameter smaller than the diameter of the first portion.

17. The ink ribbon supporting cassette according to claim 10, wherein the rotating body has a cylindrical shape, and
the shaft is inserted in a cavity in a center of the rotating body.

18. The ink ribbon supporting cassette according to claim 10, further comprising a spring which biases the second rod in a direction separating from the plate.

19. The ink ribbon supporting cassette according to claim 10, further comprising a second projection provided for the second rod and extending in a direction orthogonal to the rotational center.

20. The ink ribbon supporting cassette according to claim 19, wherein a direction in which the first projection extends is orthogonal to the direction in which the second projection extends.

21. The ink ribbon supporting cassette according to claim 20, further comprising a third projection that is orthogonal to the rotational center and extends in an opposite direction to the second projection.

22. The ink ribbon supporting cassette according to claim 10, wherein a part of the second rod projects from an end portion, of the rotating body, opposite to the plate.

23. The ink ribbon supporting cassette according to claim 22, wherein a diameter of the part of the second rod is decreased toward a tip of the second rod.

24. The ink ribbon supporting cassette according to claim 10, wherein a resin member is disposed between the second rod and the rotating body.

25. The ink ribbon supporting cassette according to claim 10, wherein the column further includes a cylinder extending from the second bottom surface toward the tip of the shaft and having the through-hole.

26. The ink ribbon supporting cassette according to claim 25, wherein the cylinder has a third bottom surface, a third distance between the third bottom surface and the plate being shorter than the second distance, and
the ink ribbon supporting cassette further includes a second washer between the third bottom surface of the cylinder and the shaft.

27. The ink ribbon supporting cassette according to claim 10, further comprising a cover provided for an end portion, of the rotating body, opposite to the plate, and configured to cover the head.

28. The ink ribbon supporting cassette according to claim 25, wherein the rotating body has a cavity which extends toward the plate from an end portion, of the rotating body, opposite to the plate,
the cavity is formed from: a first surface that extends toward the plate from the tip of the rotating body to a first boundary position; a second surface that extends toward the rotational center from the first boundary position to a second boundary position; and a third surface that extends toward the plate from the second boundary position,
the shaft and the column are disposed in the cavity,
the cylinder has a third bottom surface, a third distance between the third bottom surface and the plate is shorter than the second distance, and
a part of the third bottom surface of the cylinder is contactable with the second surface.

29. The ink ribbon supporting cassette according to claim 10, wherein the shaft includes a fourth projection extending in a direction intersecting with the rotational center,
the fourth projection has a fourth surface and a fifth surface which are orthogonal to the rotational center, a distance between the fourth surface and the plate being longer than a distance between the fifth surface and the plate, and
the fourth surface of the shaft is contactable with a part of a sixth surface, of the rotating body, facing the plate.

30. The ink ribbon supporting cassette according to claim 10, wherein the plate is contactable with a sixth surface, of the rotating body, facing the plate.

31. The ink ribbon supporting cassette according to claim 29, wherein the rotating body includes a bearing configured to receive the shaft, and
the sixth surface is formed by a part of the bearing.

32. A printing apparatus comprising:
an installing section in which the ink ribbon supporting cassette as defined in claim 10 is installed;
a motor configured to rotate the rotating body of the ink ribbon supporting cassette that has been installed in the installing section; and
a thermal head configured to heat an ink ribbon which has been fed out from the ink ribbon supporting cassette in response to rotation of the body by the motor.
